(19) United States
(12) Patent Application Publication
(10) Pub. No.: US 2018/0357734 A1
(43) Pub. Date: Dec. 13, 2018

(54) SCALABLE COMPUTING SYSTEMS AND METHODS FOR INTELLECTUAL PROPERTY RIGHTS AND ROYALTY MANAGEMENT

(71) Applicant: OLE MEDIA MANAGEMENT (GP) INC., Toronto (CA)

(72) Inventors: Robert Ott, Toronto (CA); Christopher Giansante, Etobicoke (CA)

(21) Appl. No.: 16/006,515

(22) Filed: Jun. 12, 2018

Related U.S. Application Data
(60) Provisional application No. 62/518,415, filed on Jun. 12, 2017.

(51) Int. Cl. G06Q 50/18; G06N 7/02; G06F 17/30; G06Q 40/00

(52) U.S. Cl. CPC G06Q 50/184; G06Q 40/125; G06F 17/30312; G06N 7/023

(57) ABSTRACT

Scalable computing systems and methods for the management of intellectual property assets and royalty payments. Income can be derived from a number of different sources in association with intellectual property assets. The data from these sources can be conformed into a common format to facilitate the management of intellectual property assets and royalty payments. Intellectual property assets can be organized into deals and can be stored in a database. The deals can also include parameters such as rate tables, rights holders associated with the assets of the deal. With the conformed data, the asset listings in the statements can be matched to the assets in the database. The matching can be done automatically, using fuzzy matching or manually if the automatic or fuzzy matching fails to produce a match. The royalties can then be calculated in parallel for all rights holders of a given asset across all jurisdictions using a dynamic flow network created for particular asset deal relationships.

### CROSS-REFERENCE TO RELATED APPLICATION

This application claims the benefit of U.S. Provisional Patent Application No. 62/518,415, filed Jun. 12, 2017, the entire contents of which are hereby incorporated by reference.

### FIELD

The present disclosure is related to the field of scalable computing systems and, in particular, to scalable computing systems with applications in the management of intellectual property rights and the payment of royalties associated thereto.

### INTRODUCTION

Intellectual property can have a number of different rights holders. Rights to a piece of recorded music, for example, are typically split across three separate intellectual property assets, i.e. the musical work, sound recording and performers' performance. Rights in the musical work might be held by one or more composers or music publishers; Rights in the sound recording would typically be owned by a record company or producer; and rights in the performer's performance would typically be owned by the performer(s) and/or their record companies. Individual rights can also be sold or licensed to other interested parties. Additionally, the rights holders of a particular intellectual property asset can be different based on the territory or the nature of the rights involved (e.g. reproduction rights, public performance rights, etc.). It can be difficult to keep track of all of the different rights holders particularly when royalties which are received from a number of different jurisdictions and sources.

In most jurisdictions around the world, collective societies collect royalty payments from parties who want to use a particular intellectual property asset and pass the royalties on to the rights holder or a rights manager for distribution to the appropriate rights holders. Each collective society has their own format for providing royalty statements. This requires individual analysis and calculations to be made for reach statement from each collective society when determining the royalties payable to a rights holder.

Additionally, the collective societies may collect royalties that are not properly matched to intellectual property assets as registered with the collective society. These assets are typically included in an unclaimed royalties list and though the list may not be disclosed to the public, a rights holder can submit their assets to a collective society and receive any unpaid royalties associated therewith. This can be labor intensive when requests must be submitted to a number of collective agencies around the world. Collective agencies can confidentially release the unclaimed royalties list to rights managers which can then claim the royalties for any assets under their management. However, once again as each collective agency uses their own format for the unclaimed royalty list, this can be a time-consuming process.

It is, therefore, desirable to provide a system and method to manage the intellectual property rights and royalty payments associated with intellectual property assets that overcomes the difficulties of the prior art.

### SUMMARY

A system and method can be provided for the management of intellectual property assets and royalty payments. Intellectual property assets can be organized into deals and can be stored in a database. The deals can also include parameters such as rate tables, rights holders associated with the assets of the deal. The system and method can receive statements from income sources and parse the statements such that the data is conformed to a common format. With the data in a common format, the asset listings in the statements can be matched to the assets in the database. The matching can be done automatically, using fuzzy matching or manually if the automatic or fuzzy matching fails to produce a match. The royalties can then be calculated for all of the rights holders of a given asset across all jurisdictions and sources, and in parallel for a plurality of deals, using a dynamic flow network created for particular asset deal relationships.

The above system and method for conforming of the statement data into a common format can also be applied to the unclaimed royalties list for different collective societies, by a rights manager. A user can then submit an asset to a rights holder who can then use the same line matching described above to see if the user has unclaimed royalties in any jurisdiction. This can be done without disclosing the unclaimed royalties list to the user.

In a broad aspect, there is provided a method for scalable computing in a computing device and for managing intellectual property rights and royalties, the method comprising: storing a plurality of deals in a database of a computing device, each of the plurality of deals having associated therewith at least one deal asset, the at least one deal asset associated with at least one of the plurality of deals, at least one rate table and at least one rights holder; receiving, by the computing device, at least one statement of royalties from at least one income source, the statement comprising at least one statement line, the statement line corresponding to a statement asset, the statement line comprising a plurality of statement line data; conforming, by the computing device, the plurality of statement line data from each of the at least one statement lines in each of the at least one statements received from each of the at least one income sources into a plurality of conformed data, wherein each of the plurality of conformed data is in a common format; associating, by the computing device, using the plurality of conformed data, the at least one statement asset with the at least one deal asset; calculating, by the computing device, a deal royalty payment payable to the at least one rights holder based on the at least one of the plurality of deals associated with the at least one deal asset associated with the at least one statement asset and the at least one rate table.

In some embodiments, the associating can be performed using fuzzy matching.

In some embodiments, the at least one of the plurality of deals can further comprise at least one territory parameter, the territory parameter modifying the calculation of the deal royalty payment.

In some embodiments, the method may further comprise generating a dynamic flow network for each at least one deal asset, wherein each dynamic flow network comprises a plurality of edges and a plurality of vertices.

In some embodiments, each of the plurality of edges has a respective capacity value.

In some embodiments, the respective capacity value is selected from a finite set of values.

In some embodiments, at least one constrained edge of the plurality of edges has a respective constraint.

In some embodiments, each of the at least one constrained edge has a respective entry vertex of the plurality of vertices, and wherein for each respective entry vertex, and the method may further comprise determining whether an edge constraint of the at least one constrained edge is met by the at least one deal asset.

In some embodiments, the method can further comprise generating a dynamic flow network based on the at least one of the plurality of deals associated with the at least one deal asset associated with the at least one statement asset, the at least one rate table, and the at least one rights holder, wherein the step of calculating comprises traversing the dynamic flow network.

In some embodiments, the at least one deal asset is associated with a plurality of associated deals, and the method may further comprise the computing device generating a plurality of dynamic flow networks for the plurality of associated deals, and merging the plurality of dynamic flow networks into a merged dynamic flow network.

In some embodiments, the method may further comprise processing the dynamic flow network for each at least one deal asset in parallel.

In some embodiments, the method can further comprise the step of submitting, by the computing device, the at least one deal asset to a registrar of an income source for registration of the at least one deal asset with the registrar.

In another broad aspect, there is provided a scalable computing system for managing intellectual property rights and royalties, the system can comprise: a database including storing a plurality of deals, each of the plurality of deals having associated therewith at least one deal asset, the at least one deal asset associated with at least one of the plurality of deals, at least one rate table and at least one rights holder; and a computing device configured to receive at least one statement of royalties from at least one income source, the statement comprising at least one statement line, the statement line corresponding to a statement asset, the statement line comprising a plurality of statement line data; conform the plurality of statement line data from each of the at least one statement lines in each of the at least one statements received from each of the at least one income sources into a plurality of conformed data, wherein each of the plurality of conformed data is in a common format; associate using the plurality of conformed data, the at least one statement asset with the at least one deal asset; calculate a deal royalty payment payable to the at least one rights holder based on the at least one of the plurality of deals associated with the at least one deal asset associated with the at least one statement asset and the at least one rate table.

In some embodiments, the computing device can be further configured to associate the at least one statement asset with the at least one deal asset using fuzzy matching.

In some embodiments, the at least one of the plurality of deals can further comprise at least one territory parameter, the territory parameter modifying the calculation of the deal royalty payment.

In some embodiments, the computing device is further configured to generate a dynamic flow network for each at least one deal asset, wherein each dynamic flow network comprises a plurality of edges and a plurality of vertices.

In some embodiments, each of the plurality of edges has a respective capacity value, wherein the respective capacity value is selected from a finite set of values.

In some embodiments, at least one constrained edge of the plurality of edges has a respective constraint, wherein each of the at least one constrained edge has a respective entry vertex of the plurality of vertices, and wherein for each respective entry vertex, the computing device is further configured to determine whether an edge constraint of the at least one constrained edge is met by the at least one deal asset.

In some embodiments, the computing device can be further configured to generate a dynamic flow network based on the at least one of the plurality of deals associated with the at least one deal asset associated with the at least one statement asset, the at least one rate table, and the at least one rights holder, where in the computing device is configured to calculate a deal royalty payment payable after traversing the dynamic flow network.

In some embodiments, the at least one deal asset is associated with a plurality of associated deals, the computing device is further configured to generate a plurality of dynamic flow networks for the plurality of associated deals, and merge the plurality of dynamic flow networks into a merged dynamic flow network.

In some embodiments, the system comprises a plurality of computing devices, each of the computing devices configured to process the dynamic flow network for each at least one deal asset in parallel.

In some embodiments, the computing device can be further configured to submit the at least one deal asset to a registrar of an income source for registration of the at least one deal asset with the registrar.

### BRIEF DESCRIPTION OF THE DRAWINGS

Embodiments of the present invention will now be described in detail with reference to the drawings, in which:

FIG. 1 is a schematic block diagram of a scalable computing system in accordance with at least some embodiments;

FIG. 2A is a process flow diagram depicting a method for creating a new deal in accordance with at least some embodiments;

FIG. 2B is a process flow diagram depicting a method for adding assets to a deal in accordance with at least some embodiments;

FIG. 3 is a process flow diagram depicting a method for the registration of assets with a registrar in accordance with at least some embodiments;

FIG. 4 is a process flow diagram depicting a method for the processing of statement files in accordance with at least some embodiments;

FIG. 5 is a simplified process flow diagram depicting a method of scalable computing in accordance with at least some embodiments;

FIG. 6 is a process flow diagram depicting the manual mapping of a parser new parser in accordance with at least some embodiments;

FIG. 7 is a process flow diagram depicting the overriding of by the parser of mapping elements in accordance with at least some embodiments;

FIG. 8 is a process flow diagram depicting the method of statement line matching in accordance with at least some embodiments;

FIG. 9 is a graphical depiction of the method of fuzzy matching of statement lines to assets in accordance with at least some embodiments;

FIG. 10A is a block diagram of an example song/deal/deal asset relationship where only a single deal is associated with an asset;

FIG. 10B is a dynamic flow network diagram of the relationship shown in FIG. 10A;

FIG. 11A is a block diagram of an example song/deal/deal asset relationship where the asset is associated with multiple deals;

FIG. 11B is the dynamic flow network diagram of the relationship shown in FIG. 11A;

FIG. 12A is a block diagram of an example song/deal/deal asset relationship where the deal includes a deal modifier;

FIG. 12B is the dynamic flow network generated diagram of the relationship shown in FIG. 12A;

FIG. 13A is a block diagram of an example song/deal/deal asset relationship where the rate table of one of the participants includes a rate table modifier;

FIG. 13B is the dynamic flow network diagram of the relationship shown in FIG. 13A;

FIG. 14 is the dynamic flow network diagram generated by combining the dynamic flow networks of FIG. 10B, FIG. 11B, FIG. 12B and FIG. 13B;

FIG. 15 is a flowchart depicting a validation process in accordance with at least some embodiments;

FIG. 16A is a process flow diagram of a method for scalable computing in a computing device in accordance with at least some embodiments;

FIG. 16B is a process flow diagram for a method of traversing a dynamic flow network in accordance with some embodiments; and

FIGS. 17A and 17B are process flow diagrams for ingesting and registering assets in accordance with at least some embodiments.

### DESCRIPTION OF VARIOUS EMBODIMENTS

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details, or with other methods, components, materials, etc. In other instances, well-known methods, procedures and components have not been described in detail have not been shown or described in detail to avoid unnecessarily obscuring descriptions of the embodiments, and since these are known to those skilled in the art. Furthermore, it should be noted that this description is not intended to limit the scope of the embodiments described herein, but rather as merely describing one or more exemplary implementations.

Unless the context requires otherwise, throughout the specification and claims which follow, the word “comprise” and variations thereof, such as, “comprises” and “comprising” are to be construed in an open, inclusive sense, that is as “including, but not limited to.”

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

Reference throughout this specification to “one embodiment” or “an embodiment” means that a particular feature, structures, or characteristics may be combined in any suitable manner in one or more embodiments. In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments, but is not necessarily included. Thus, the present technology can include a variety of combinations and/or integrations of the embodiments described herein.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

The terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device.

Similarly, throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), optical pathways (e.g., optical fiber), electromagnetically radiative pathways (e.g., radio waves), or any combination thereof. Exemplary communicative couplings include, but are not limited to, electrical couplings, magnetic couplings, optical couplings, radio couplings, or any combination thereof.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, mouse, touchscreen, or the like), and at least one output device (e.g. a display screen, a printer, a wireless radio, or the like) depending on the nature of the device.

It should also be noted that there may be some elements that are used to implement at least part of one of the embodiments described herein that may be implemented via software that is written in a high-level computer programming language such as one that employs an object-oriented paradigm. Accordingly, the program code may be written in Java, C++ or any other suitable programming language and may comprise modules or classes, as is known to those skilled in object-oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, EEPROM, magnetic disk, optical disc) or a device that is readable by a general or special purpose programmable device. The software program code, when read by the programmable device, configures the programmable device to operate in a new, specific and predefined manner in order to perform at least one of the methods described herein.

The description sets forth various embodiments of the systems, devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory computer-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

Intellectual property rights management and royalty payment processing systems generally involve complex registration processes, due to the multiple types of royalties, many geographical jurisdictions, organizational differences, etc. To date, no single platform solution has emerged to manage multiple intellectual property rights (e.g., sound recordings, audio visual secondary rights (AVSR), music publishing, etc.) in a single system.

Significant growth in the amount of data created for intellectual property assets—e.g., due to the shift to a digital environment for consumers—has resulted in a proliferation of poor data and an inability for new service providers to identify the correct rights holders for royalty payment purposes. Often there is no authoritative, single database to which intellectual property assets can be matched.

Collective societies, which may be specific to jurisdictions that collect royalties on behalf of rights holders, and flow through the associated royalties) may collect royalties that may not be properly matched to IP assets as registered with the collective society. These assets are typically included in an unclaimed royalties list and—though the list may not be disclosed to the public—a rights holder can submit their assets to a collective society and claim unpaid royalties associated therewith. Generally, this is a labor intensive, manual process as the rights holder may be required to submit lists to a number of collective agencies around the world. Further complicating this already difficult process, are: a) the inability to identify the correct rights holders; b) incomplete & incorrect information about IP assets; c) demands on rights collectives and Digital Service Providers (DSPs), which process millions of lines of data; d) the thousands of person hours required to manually scrub data; e) the time required for filing domestic and foreign copyright registrations, often begun only when a recording is actually released; f) multiple or inaccurate claims for the same rights, resulting in indefinite disputes; g) international collaborations with less than all creators asserting their rights; and many others.

The described embodiments generally provide a scalable computing system for IP asset management and royalty payment processing, with the general capabilities of: a) data matching and conforming, able to take any disparate data set, ingest, conform, analyze and summarize it for a multitude of rights management use cases; b) conforming and cleaning data, leveraging a sophisticated matching and suggestion engine that is scalable to multiple rights management business needs; and c) automating much of the historically manual process of rights management (e.g., registrations, data matching, learned matching, etc.).

More particularly, the described embodiments can address the explosion in data sets and the lack of intelligence in existing rights management solutions by providing a scalable computing approach. The described embodiments enable automation of full-cycle registrations for IP assets (queue for registration, file generation and delivery, and acknowledgement file retrieval and processing; automation of IP asset chain of title based on a one-time configuration; verification that data requirements for registration and processing are met before promoting assets into live database; advanced processing configuration for allocating income and royalty amounts based on income sources, income types, and territories; and real-time royalty payment processing (as opposed to batch processing in conventional approaches).

Accordingly, the various embodiments described herein generally relate to scalable computing systems and methods for intellectual property and royalty rights management.

Computing systems are designed to satisfy various requirements, such as load capacity and performance speed. When those computing systems need to process a larger amount of data, their scalability can be limited by the original design and/or hardware scalability. For example, when a computing system operates based on a single process, it may be difficult to adapt that computing system for parallel processing (e.g., multi-threaded processes). Instead, to adapt that example computing system for larger processing loads, higher performing hardware resources are likely required.

In a computing system for automatically calculating and determining royalties owed to a party, or in relation to an asset, for example, the computing system can be designed to automatically calculate a royalty in a single process. However, when the number of assets and parties grows, it can be difficult to scale this system in a way that can maintain the original design performance. The addition of higher performance hardware resources can be one way to scale the but the hardware resources also come with procurement and maintenance costs, and other issues.

Also, the design of computing systems typically considers specific factors related to the application of that computing system. For example, in the context of a royalty management system, the different royalty arrangements according to region can multiply the number of calculations required. Also, depending on the region associated with a party or asset, different regulations may apply, which must be considered by the calculation process.

The described embodiments generally provide systems and methods for scalable computing in an intellectual property and royalty rights management system. The scalable computing may be provided by employing dynamic flow networks, which can be constructed for each intellectual property asset. The dynamic flow networks may be computed by a plurality of independent and parallel processes, greatly reducing the time and computer resources required to calculate royalties over a large portfolio of assets for a large number of participants.

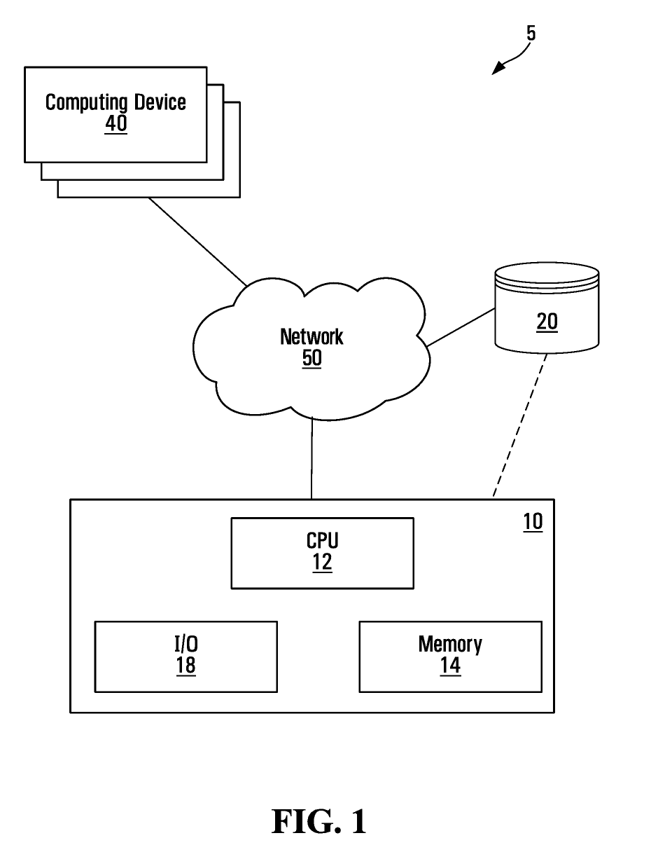

Reference is now made to FIG. 1, which illustrates a schematic block diagram of an example scalable computing system 5. The scalable computing system 5 may have at least one client computing device 40, a system database 20 and at least one server computing device 10, all of which may be in communication via a network 50. In some embodiments, database 20 may be directly coupled to server computing device 10 via a local bus or other communication interface.

The client computing devices 40 may be any networked device operable to connect to the network 50. A networked device may couple to the network 50 through a wired or wireless connection.

The client computing device 40 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these. Client computing device 40 may be provided with client software for interfacing with server computing device 10, such as a web browser or client application, which can provide a user interface for allowing a user of client computing device 40 to view output from, and provide input to, server computing device 10.

The network 50 may be any network capable of carrying data, including the Internet, Ethernet, public switch telephone network (PSTN), integrated services digital network (ISDN), digital subscriber line (DSL), coaxial cable, fiber optic, satellite, mobile, wireless (e.g. Wi-Fi, WiMAX), fixed line, local area network, wide area network, and others, including any combination of these, capable of interfacing with, and enabling communication between the computing device 40, the system database 20 and the server computing device 10.

The server computing device 10, the client computing device 40, and the system database 20 may connect to the network 50 or a portion thereof via suitable network interfaces.

The system database 20 can be a computing device with, e.g., a processor and local memory, which can serve as a central repository of data for server computing system 110, and other data as described herein.

The server computing device 10 generally has a processor 12, an interface component 18 and a memory 14. The processor 12, the interface component 18 and the memory 14 can communicate with each other. The memory 14 can include one or more local databases (not shown) which may replicate database 20 or may be distinct. In FIG. 1, the server computing device 10 is shown as one element for ease of exposition. However, generally there may be a plurality of server computing devices 10 connected via the network 50.

In some embodiments, each of the processor 12, the interface component 18, and the memory 14 may be combined into a fewer number of components or may be separated into further components. Furthermore, the processor 12, the interface component 18, and the memory 14 may be implemented in software or hardware, or a combination of software and hardware.

The processor 12 may be any suitable processors, controllers or digital signal processors that can provide sufficient processing power depending on the configuration, purposes and requirements of the server computing device 10. In some embodiments, the processor 12 can include more than one processor with each processor being configured to perform different dedicated tasks.

The processor 12 can be configured to control the operation of the server computing device 10. The processor 12 can initiate and manage the operations of each of the interface component 18 and the memory 14.

The interface component 18 may be any interface that enables the server computing device 10 to communicate with other devices and systems, to receive input data, and to transmit output data. In some embodiments, the interface component 18 can include at least one of a serial port, a parallel port or a USB port. The interface component 18 may also include at least one of an Internet, Local Area Network (LAN), Ethernet, Firewire, modem or digital subscriber line connection. Various combinations of these elements may be incorporated within the interface component 18.

For example, the interface component 18 may receive input from various input devices, such as a mouse, a keyboard, a touch screen, a thumbwheel, a track-pad, a track-ball, a card-reader, voice recognition software and the like depending on the requirements and implementation of the server computing device 10.

The memory 14 can include RAM, ROM, one or more hard drives, one or more flash drives or some other suitable data storage elements such as disk drives, etc. The memory 14 can be used to store an operating system and software applications. For instance, the operating system can provide various basic operational processes. The programs can include various user programs so that a user can interact with the interface component 18 to perform various functions such as, but not limited to, viewing and/or responding to the notifications generated by the server computing device 10.

The memory 14 can store data related to the accounts associated with the server computing device 10, for example. The accounts can relate to a user, and/or a specific product or project whose status is being monitored by the server computing device 10.

In some embodiments, a user can add a deal to the scalable computing system for intellectual property and royalty rights management. A deal can represent a contract between a rights holder of an asset, (a payee) and rights manager. A deal can define which assets are associated to the deal, the royalty rates to be paid in association with the asset and can include a breakdown of rights by territory, and for songs can also define the composers of the song and the publishers that represent them.

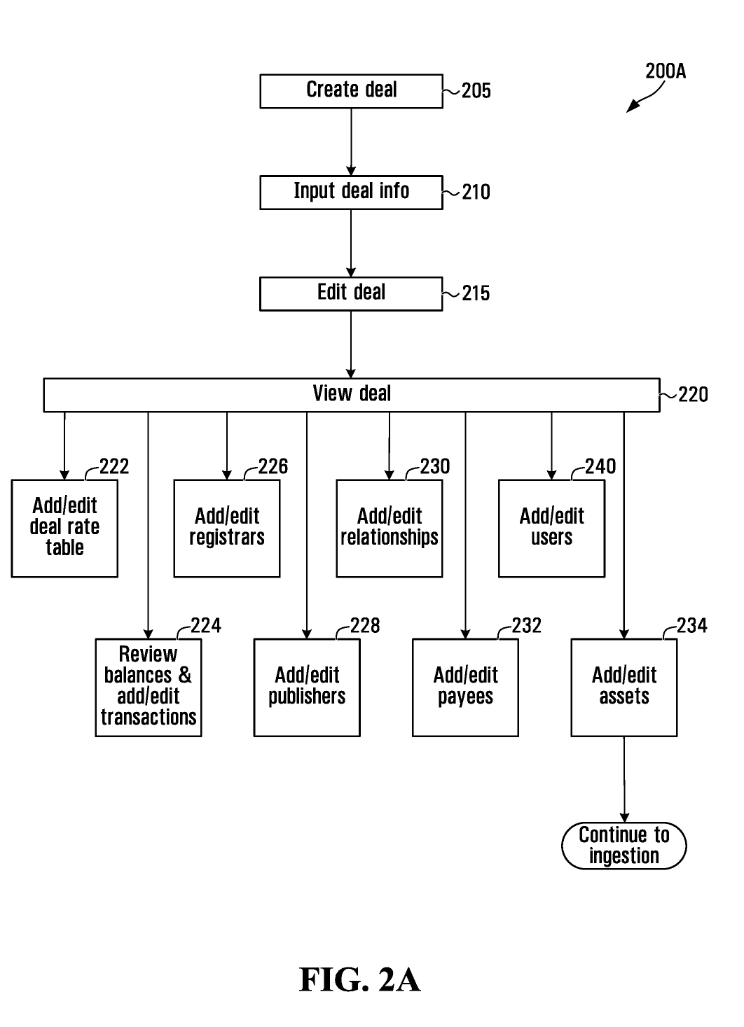

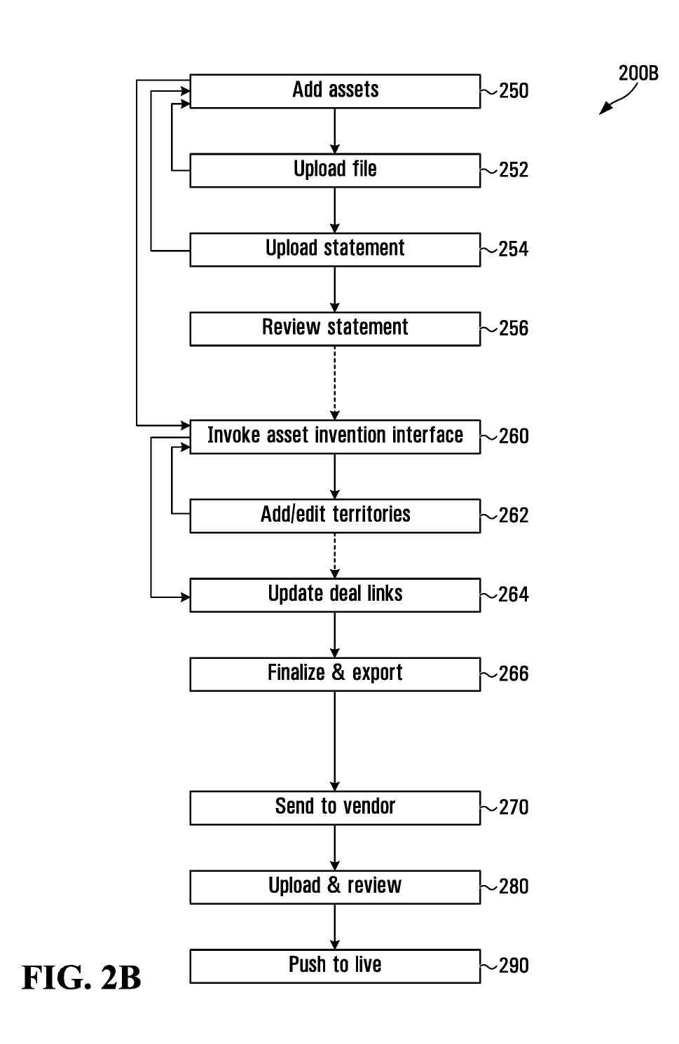

Referring now to FIG. 2A, there is illustrated a process flow diagram for a method of creating a deal in the scalable computing system of FIG. 1. Method 200A may be carried out by a computing device, such as computing device 40 of FIG. 1, which generates and displays a user interface to a user and processes inputs to produce outputs that can be displayed to the user or transmitted to a server computing device, such as server computing device 10 of FIG. 1.

At 205, a user may create a new deal by selecting an appropriate user interface element. After the new deal is created at 210, the user can input a deal name, a deal group and a company. The deal name can be unique to the deal. A deal can also be part of a deal group.

At 215, the user can edit the deal by inputting addition deal information. The additional information may include, for example, a designated customer service manager (wCRMx), controlled rights, term and territories.

At 220, the user can view the deal and, optionally, can edit the deal further. At this stage the user can add, edit and update the information associated with the deal.

At 222, the user can add a deal rate table to the deal, as described further herein. For example, the user can fill out the income type information. Different royalty rates may be paid depending on the different income type. For example, the royalties may be different for one party in relation to mechanical reproduction and public performance rights of an asset.

Deal modifiers can also be added at 222. Modifiers can provide special conditions to the royalty rate such as different rate allocations for royalties in different territories.

At 224, the user can review deal balances and can add transactions to the deal.

At 226, the user can add registrars applicable to the assets to the deal. The registrars can include collective societies, for example, which can collect royalties from income sources and pass the collected royalties along to the rights manager for distribution to the rights holders.

At 230, composer-publisher relationships can be added to the deal. Depending on the asset type, the asset can have a composer. The composers can be added to the deal and associated to the publishers that represent them.

Publisher groups can be added to the deal at 228.

At 232, the user can add payee participants to the deal and manage cross-payees for a deal.

At 240, additional users can be added to the deal and permissions can be set for the users to limit access to specific deals and specific information within a deal.

At 234, a user can add new assets to the deal using, e.g., the ingestion flow described with reference to FIG. 2B.

Referring now to FIG. 2B, there is illustrated a process flow diagram for a method of adding new assets to a deal in the scalable computing system of FIG. 1. Method 200B may continue from method 200A of FIG. 2A (though in some cases it may be carried out independently) and in general may be carried out by a computing device, such as computing device 40 of FIG. 1, which generates and displays a user interface to a user and processes inputs to produce outputs that can be displayed to the user or transmitted to a server computing device, such as server computing device 10 of FIG. 1.

An asset can be any intellectual property asset, such as a song, a production, a literary work, a television episode, a film, etc.

A song can have one or more composer and each composer can own a portion of the song. Composers assigned to a song generally reflect the song's authorship shares. This does not necessarily affect who gets paid for a performance, recording or reproduction of the song, as the accompanying rights may have been sold to a different party. A production, such as a film or television series, does not have composers assigned, but can have a producer or distributor assigned.

Although, for ease of exposition, the embodiments herein are described primarily as relating to musical assets (e.g., songs and albums), the described embodiments can also be used to manage other types of IP assets, such as literary works, television shows, films, etc., bearing in mind that the metadata and agreements surrounding such assets may vary, as noted.

At 250, the user can add an asset to a deal. The asset can be added as part of a batch. For example, from the add asset interface, the user can upload an inventory file using an inventory file upload interface at 252, which can contain information related to one or more assets. The inventory file can be in any format readable by the computing device. This can include a text file such a comma separated values (CSV) file or a fixed width or other delimited text file.

In some cases, the user may also upload statement data using a statement data interface at 254 and review the statement data at 256, if it is available, using a statement review interface.

At 260, an asset inventory interface can be invoked to allow the user to review all assets that have been added, whether through manual addition or uploading as a batch.

At 262, the user can add or update the territories associated with each asset.

At 264, the user can add or updates links between the assets and deals, for each asset.

At 266, the user can edit, merge and match the assets to be imported using the asset inventory interface, and export the asset inventory data as batch data.

Optionally, at 270, the exported batch data from the asset inventory interface can be transmitted to a vendor. The vendor can also edit the batch data, and return the data to the user.

At 280, the user can upload batch data, whether or not edited by the vendor, into the asset inventory interface. If necessary, the user may review and/or approve the vendor edits.

At 290, an administrator can review the assets in the asset inventory interface and select the complete assets to be added to the intellectual property rights and royalty management system.

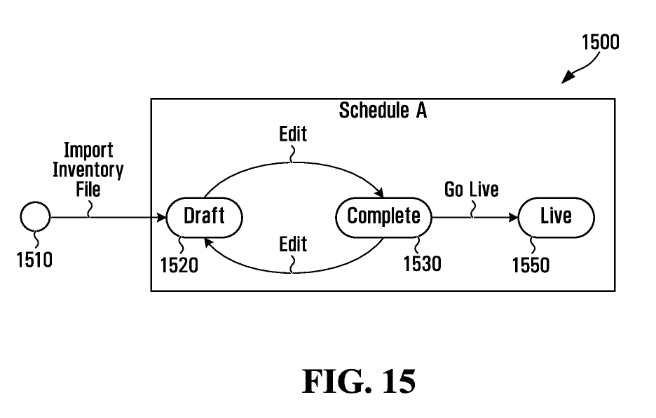

In some embodiments, only validated assets can be used in the intellectual property rights and royalty management system. In such cases, the asset inventory data can be verified using validation rules. As shown in FIG. 15, when the asset inventory data is initially created at 1510 (e.g., using the asset inventory interface) it can be considered a draft 1520. Drafts may be edited and, once the validation rules have been met the asset inventory data can be considered complete 1530. Additional edits may be required to pass the validation rules. Such validation rules may include, for example, a requirement to have certain attributes, such as a Date of Creation, Composer(s), and Deal(s). Each deal may be linked to specific composers, so the Composer added may require at least one Deal with which they are associated.

In some embodiments, assets may be considered to be in one of three states: draft 1520 (e.g., not yet validated); complete 1530 (e.g., all validation rules passed); and live 1540 (e.g., all validation rules passed, and imported for use by the system, with no further edits permitted). A draft asset 1520 may be edited and can become a complete asset 1530. Only a complete asset 1530 can be converted to a live asset 1550. A complete asset 1530 can also revert to a draft asset 1520.

In some cases, a user or administrator can, at 290, review the asset inventory data and select the complete assets that have passed all validations to be added to the intellectual property rights and royalty management system.

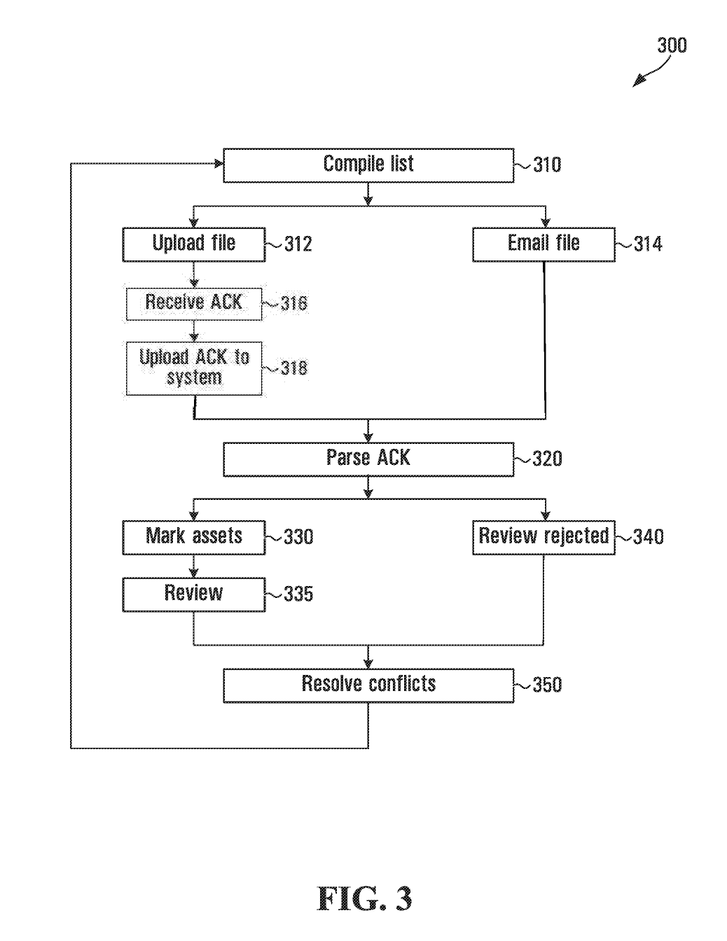

Referring now to FIG. 3, there is illustrated a process flow diagram for a method of registering assets with a registrar or collective society in the scalable computing system of FIG. 1. Method 300 in general may be carried out automatically by a server computing device, such as computing device 10 of FIG. 1, which can processes input files to determine data to process, and can generate and display a user interface to obtain user input as necessary.

Registration with a collective society can be done for new assets or to update an asset when information related to the asset has changed and requires updates be sent to the registrar, such as for a change of ownership.

At 310, a listing of assets to be registered with a collective society can be compiled. This list can be compiled by the system by adding recently added assets or assets with a recent change which requires registration to be added to the list. The list can be compiled into a registration file to be sent to a registrar. The registration file may be in one or more acceptable file formats or types, such as, a comma-separated values (CSV), spreadsheet, binary file, XML file, or other format or type as may be defined. In some cases, the list may be received as input.

The registration file can be scheduled to be sent by the server computing device to the registrar immediately or on a scheduled delivery cycle. The registrar for each collective society can have different requirements for registration. Some registrars can accept a direct upload of the registration file from the server computing device to the registrar's FTP site as at 312. In such cases, the registrar may generate and store an acknowledgement (ACK) file on the FTP site; the server computing device can check the FTP site for the ACK file at 316, and retrieve it once it is available at 318. Alternatively, the registrar can require the registration file to be sent by email as at 314.

If an ACK file has been received at the server computing device, the ACK file can be parsed at 320. The ACK file can indicate which assets were registered and which assets were rejected. In some embodiments, if an ACK file is not available, or has not been retrieved, method may end without parsing the ACK file and/or resolving conflicts.

The status of the registered assets can be updated at 330, while the rejected assets may be reviewed by a user in a user interface provided by the server computing device, at 340.

A registration dashboard can be provided to a user by the server computing device at 335, which can allow the user to view the status for all assets at any point during the registration process. In some cases, the registration dashboard may be the same one as used at 340.

Optionally, at 350, the rejected assets can be reviewed by the user to resolve any conflicts. Once the conflicts have been resolved, the assets can be resubmitted to the registrar for registration at 310.

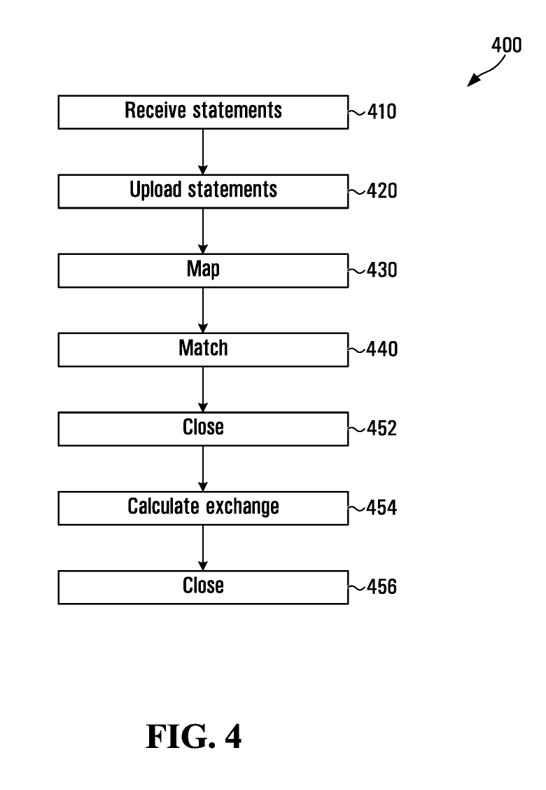

Referring now to FIG. 4, there is illustrated a process flow diagram for a method of processing statement files in the scalable computing system of FIG. 1. Method 400 in general may be carried out by a server computing device, such as server computing device 10 of FIG. 1.

Statements related to assets can be received from various sources. The statements can include statements from collective societies which can collect royalties from income sources and pass the royalties along to a rights manager to be paid to the rights holders. Method 400 may be used to input statement data for use by the scalable computing system, such as scalable computing system 5 of FIG. 1.

At 410, a statement can be received from an income source.

At 420, the statement can be uploaded to, or received by the server computing device. Each line in a statement can indicate the name of the asset and related royalty earnings for the period of the statement. Each statement line can be matched against an asset in the intellectual property rights and royalty management system, which can assign the money received in relation to the asset to any deals to which the asset is linked. Finally, the money can be assigned to the payees inside each deal according to specific rates, as described further herein. An asset can be connected to more than one deal, in which case the royalties are divided amongst the deals according to the deal shares. The uploaded statement file can be associated with a statement parser.

Statements may be received from different income sources in a variety of formats. Before they can be matched to assets they can be transformed into a common format by using a parser. This can be done using a generic type of parsers, such as parsers designed for CSV files, and fixed width text files. Other parsers can be configured to parse statements from specific income sources from various collective rights societies such as: AMCOS, ASCAP, BMI, CMRRA, SOCAN, SIAE, NCB, as well known to those skilled in the art. New parsers can be created using the parsers noted above as a template.

At 430, the associated parser can be executed by the server computing device to complete mappings of: 1) income sources, 2) income type, and 3) territories, against each line in the statement. These three fields can be mapped out to items in the intellectual property rights and royalty management system so that the assets can be matched: “Territory” can indicate where the money is coming from, “Income Source” can indicate who sent the money, and “Participant” can indicate what rate should be applied to the asset.

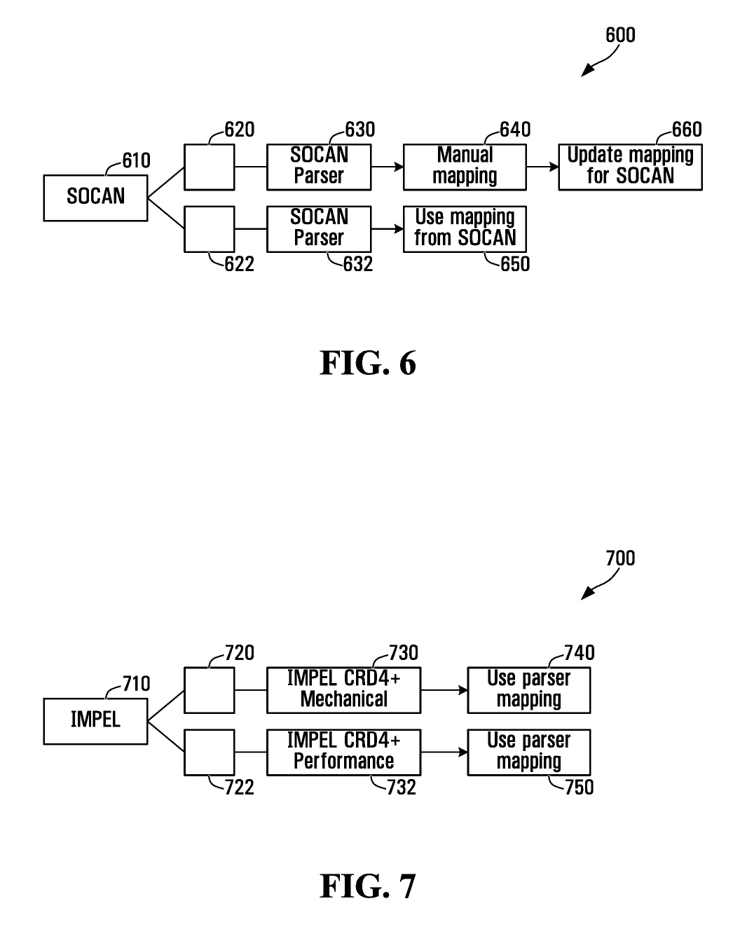

Referring briefly to FIG. 6, there is illustrated an example mapping process flow 600, which can be carried out at 430 of method 400 in some cases. Mapping process flow 600 begins at 610 by determining an income source of the data to be mapped and attempting to map the data. If the source is known and the data can be completely mapped, at 622 a determination can be made to proceed with automatic mapping. If the source is unknown, or if the data cannot be completely mapped, then a determination can be made to proceed with manual mapping at 620. For example, the manual mapping may occur the first time a statement is received from an income source. At 630, a mapping template associated with the income source may be selected (or created if one does not exist), and manual mapping can be carried out by a user at 640. Once the user has performed the manual mapping, the mapping template may be updated for the income source at 660 for subsequent use in automatic mapping.

In automatic mapping, the parser may be selected at 632, and the mapping may be carried out automatically by a processor at 650.

In some cases, the server computing device can allow the parser to override the mapping for the participants. This can be useful for cases where the Statements from an Income Source use the same text to refer to different participants.

Referring briefly to FIG. 7, there is illustrated an example mapping process flow 700, which can be carried out at 430 of method 400 in some cases. Mapping process flow 700 illustrates the process that may be followed when an income source provides different statement types. In the example shown in FIG. 7, the collecting society, IMPEL, has a statement for participant “Performance” and another for participant “Mechanical” but uses the codes 45 and 46 to refer to the different participants. Accordingly, at 720 the performance statement may be selected at 720, and a first parser may be selected at 730 and used at 740. Likewise, at 722, the mechanical statement may be selected, and a second parser for mechanical statements selected at 732 and used at 750.

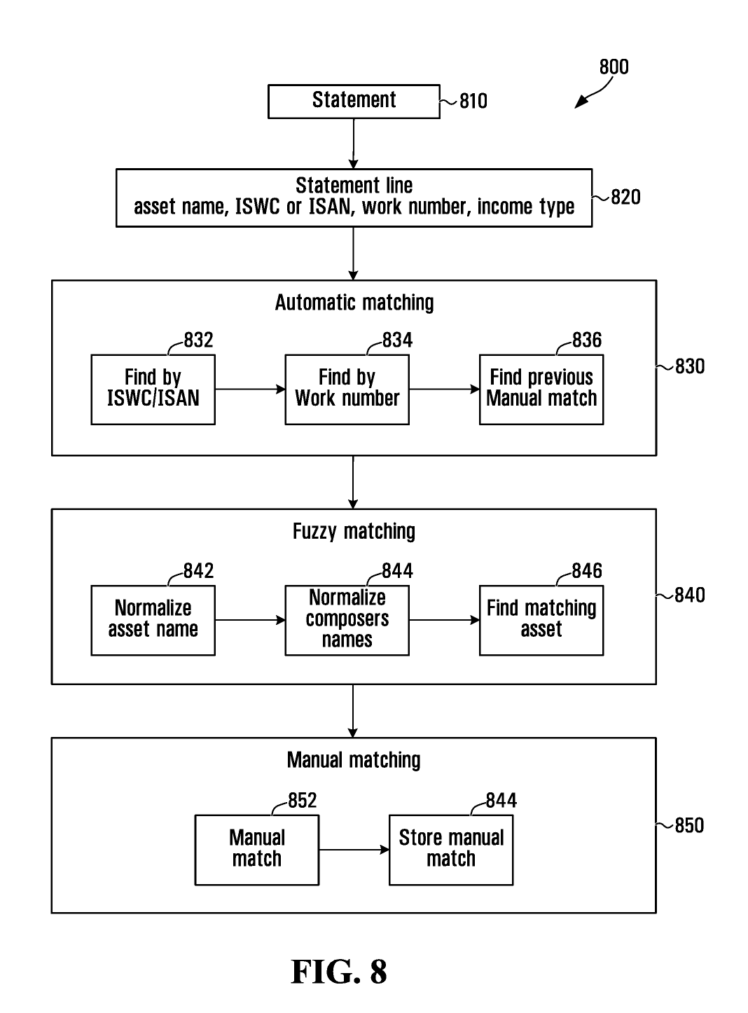

Referring once again to FIG. 4, at 440, statement line matching can be performed, to attempt to match each line on a statement to an asset. Statement line matching may happen in stages, as illustrated in more detail in FIG. 8.

Referring now to FIG. 8, there is illustrated a stage flow for a process of statement line matching 800.

At 810, the statement can be received, and at 820 the statement line matching may begin.

In a first stage, at 830, the processor may attempt automatic line matching, by first attempting to match based on a unique identifier at 832, such as ISWC (International Standard Musical Work Code) or ISAN (International Standard Audiovisual Number), following by a work number at 834, and finally based on a previous manual match at 836 (e.g., using a previous line that was matched to the same asset based on the asset name on the statement line; for song assets, the previous match can be based on name and composers).

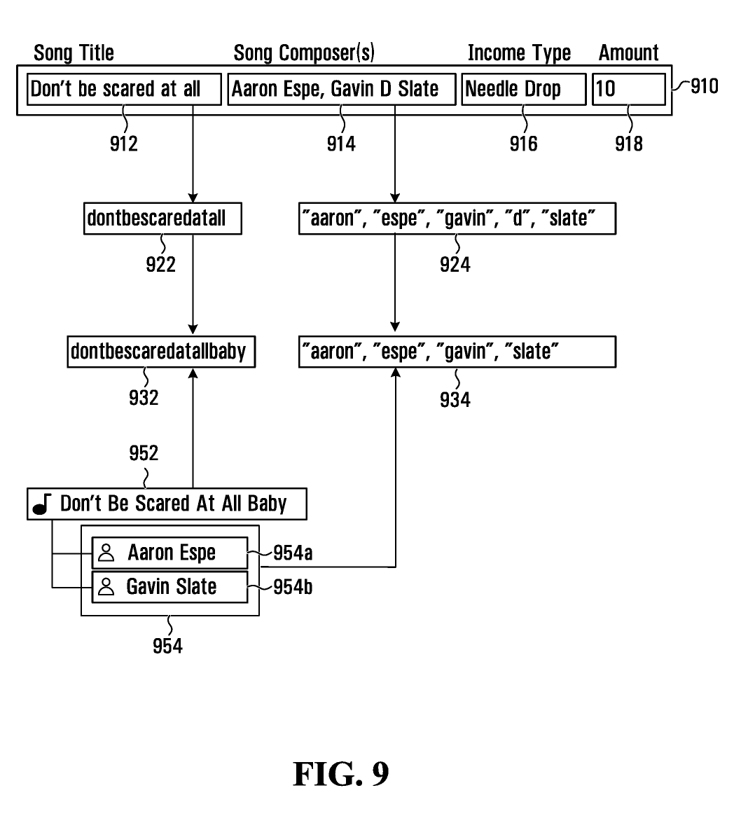

If automatic line matching is not successful, an attempt can be made to match the asset with a fuzzy match to existing assets in the system at 840. Fuzzy matching begins by normalizing the asset name at 842, normalizing composer names at 844 and then attempting a match at 866. A more detailed example of fuzzy matching is illustrated in FIG. 9. In some embodiments, the fuzzy matching may only consider assets that are live and are associated with at least one deal.

Referring briefly to FIG. 9, there is illustrated a statement line 910, which contains a song title field 912, a song composer field 914, an income type field 916 and an amount code 918. When normalizing, the song title can be reduced to lower case characters and stripped of whitespace characters, producing a normalized song title 922. When normalizing the composer field, each whitespace- or punctuation-separated element can be treated as a distinct item, and reduced to lower case characters, to produce an array of normalized name elements 924. The normalized title 922 may then be fuzzy matched to a known normalized title 932, and likewise the normalized name elements 924 may be matched to a known normalized name elements 934. The song title 952 and composer names 954 associated with the known normalized title 932 and known normalized name elements 934, respectively, can then be selected as the likeliest match.

In some cases, not all assets will be considered for fuzzy matching. For example, in some embodiments, criteria may be established for assets that can be considered for fuzzy matching, such as:

is Live

has a unique identifier

is in at least one Live deal

has composers (songs only)

is not a subcode (songs only)

When a fuzzy match is successful, the processor may store a record of the successful match in the system, which can be used in automatic line matching for future statement lines.

Referring again to FIG. 8, in a third stage, at 850, in some cases, users can override matches made automatically or through fuzzy matching, and enter missing matches manually at 852. When this happens, the manual match can be saved at 856 and used for future automatic line matching.

Once statement line matching has been performed, the royalty calculation can be used by the server computing device to calculate the payout of funds to the participants for each asset, as described further herein.

To accurately pay out royalties, several pieces of information about an asset can be used, such as:

The deals associated with the song

The participants associated with the deal

The rate tables associated with the participants

Each deal can have a percentage allocation to a song along with a set of “modifiers” that describe the conditions that the deal will be in effect. As an example, as described below, where a song is associated with multiple deals, a specific deal may be exclusively in effect for royalties from a specified territory

The participants on the deal are the entities that will get paid once the royalties have been distributed by the rights manager. For example, deals can include information composer names associated with each asset and their respective shares of royalties. Assets can be connected to deals though their composers; from that connection each composer can be assigned one or more publishers from a deal, and in some cases can have the publisher share identified also. In some cases, the publisher percentage breakdown relative to each composer can also be specified.

The rate tables can determine what percentage of the royalties the participant receives. Similar to deals, there can be “modifiers” on the association of rate tables to participants that can describe when a given rate table is in effect.

Generally, there may be two kinds of royalties for a song asset: mechanical and performance. The mechanical right is the right to reproduce a piece of music onto some media, whereas the performance right is earned when a musical work is performed publicly. Public performance occurs when a song is sung or played, recorded or live, on radio and television, as well as through other media such as the Internet, live concerts and programmed music services. Each of these types can be further broken down in terms of ownership and collection (who owns vs. who actually collects the payment): mechanical ownership (MO), performance ownership (PO), mechanical collection (MC), performance collection (PC), etc. This percentage breakdown is generally defined relative to the Publisher percentage share.

### Flow Networks

A Flow Network is a directed acyclic graph in which each edge on the graph has a given capacity constraint. In a standard Flow Network, input units are routed through the network with the goal of identifying which paths through the network are to be used and the quantity of units that are routed through each path.

Most examples of Flow Networks use static values on the capacity constraints for edges, but in the general case, a network's capacity can be adjusted on the fly. This property can be exploited for the computation of royalty amounts as described herein.

### Decision Trees

Decision Trees are a mechanism of describing an algorithm in a graphical way. Decision Trees reduce problems down to a directed acyclic graph in which each edge describes an arbitrary condition that must be met by the input before allowing the input to traverse to the linked vertex on the edge.

Similar to Flow Networks, a Decision Tree takes an input and routes it through the graph, checking the input against the edges at each vertex with the goal of finding an exit vertex.

### Dynamic Flow Network

Combining the concepts of Flow Networks and Decision Trees, a Flow Network can be constructed by a server computing device where each edge has both a capacity and a condition constraint. In this way, as the units are being routed through the graph, a check can be performed at each vertex to see if the units can be routed to the next vertex or not and a breakdown of the input value can be computed simultaneously.

Dimension: Each asset in the intellectual property rights and royalty management system can be thought of as being associated with multiple Dimensions. From the perspective of an asset, Dimensions can be simply metadata categories about the asset. For example, an asset can be associated with a deal, Income Type, Territory, participants, etc.

Dimension Value: Any given Dimension can have a distinct (typically finite) set of values that it can represent. For example, the Income Type Group Dimension can have the potential values of Mechanical, Performance, Synchronization, etc.

Vertex: The vertices in the Dynamic Flow Network can be considered as “decision points”.

Network Input: An example of the input to the Dynamic Flow Network can be the following data structure:

```
{
  amount: < statement line amount >,
  dimensions: {
    ′Deals′: < list of potential Deals on Song >,
    ′Income Type: ′the tagged income type on the statement line′,
    ′Participant′: < list of all Participants on associated deals >,
    ′Territory′: ′the tagged territory on the statement line′,
    ′Rate Table′: < list of potential rate tables on deal >,
    ′Deal Asset Links″: < deal/modifiers to percentage map >
  }
}
```

Algorithm Output: The output of the algorithm can be a series of paths through the network and the associated capacities of each path. This information can be used to compute the associated dimension values of the input and the amount of the royalty for a given participant.

A Dynamic Flow Network can be created which can represent both the discovery of the correct deals, participants, and rate tables for a given asset and determine the royalty breakdown at the same time.

Once this network is constructed, each asset and royalty amount can be routed through the network to determine which deal, participant, and rate table to use to compute the royalty amount without further modifications to the network. In addition, because the data structure of the Flow Network is not modified, the structure can be used in parallel.

Below are examples of song assets in accordance with some embodiments, and the associated royalty computations for them.

### Royalty Example 1: Single Deal

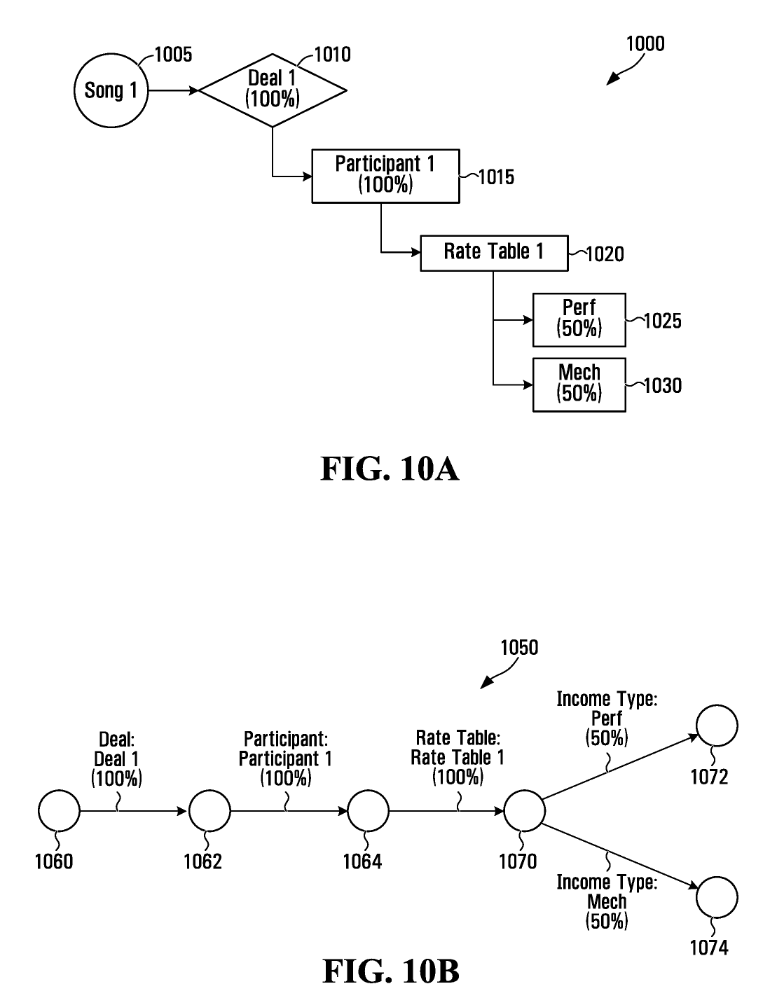

FIG. 10A illustrates a song/deal/deal asset relationship in the intellectual property rights and royalty management system where an asset is associated with a single deal. This relationship can be represented graphically as a song 1005, which has an associated deal 1010, which has a single participant 1015, and a single rate table 1020, which specifies two royalties 1025 and 1030.

Based on the single deal relationship shown in FIG. 10A, the Dynamic Flow Network 1050 shown in FIG. 10B can be generated by the server computing device.

As an illustration of how the Dynamic Flow Network of FIG. 10B can be traversed to compute a royalty payout, the following Statement Line may be considered:

| Song | Income Type | Amount | Deals |
|---|---|---|---|
| Song 1 | Mech | $10 | Deal 1 |

The following Network Input can be created by the server computing device from the statement line:

```
{
  amount: $10,
  dimensions: {
    ′deals′: [′Deal 1′],
    ′income types′: [′Mech′],
    ′participants′: [′Participant 1′],
    ′rate_tables′: [′Rate Table 1′]
  }
}
```

Note that the Network Input could potentially contain all the dimension values for the deal and participant dimensions and ignore what the Statement Line matching system encoded as the correct values. The Flow Network should be able to resolve the correct path regardless.

At each vertex, a process executed by a server computing device, such as service computing device 10 of FIG. 1, can check the conditions on the edges to see which dimension criteria are met at the edge. If all criteria are met, then the edge can be considered a candidate for traversal, however edges with higher “specificity” win in the case where two edges' conditions match the input. Specificity is a count of how many conditions have been met at each edge.

In the example of FIG. 10B, the first three edges between vertices 1060, 1062, 1064 and 1070 will all be traversed since they contain the values in the deal, participant, and rate table dimensions from the input set. At vertex 1070, a decision between “Perf” and “Mech” is made. In this case, the input set has only “Mech” Income Type, therefore the edge that matches that value will be taken, leading to vertex 1074.

Following the above logic results in the following traversal path as output:

```
[
  [
    {Deal: ″Deal 1″},
    {Participant: ″Participant 1″},
    {Rate Table: ″Rate Table 1″},
    {Income Type: ″Mech″}
  ]
]
```

and the following capacities:

[
[100%, 100%, 100%, 50%]
]

Using the traversal path and the capacities, the intellectual property rights and royalty management system can pay out $5 to “Participant 1” because of “Deal 1” and the Mech income type. The payout can be computed by multiplying the capacities traversed, and input amount, together ($10*(100%*100%*100%*50%)=>$10*50%=>$5).

More detail on how the capacities are assigned, is discussed below.

### Royalty Example 2: Multiple Deals

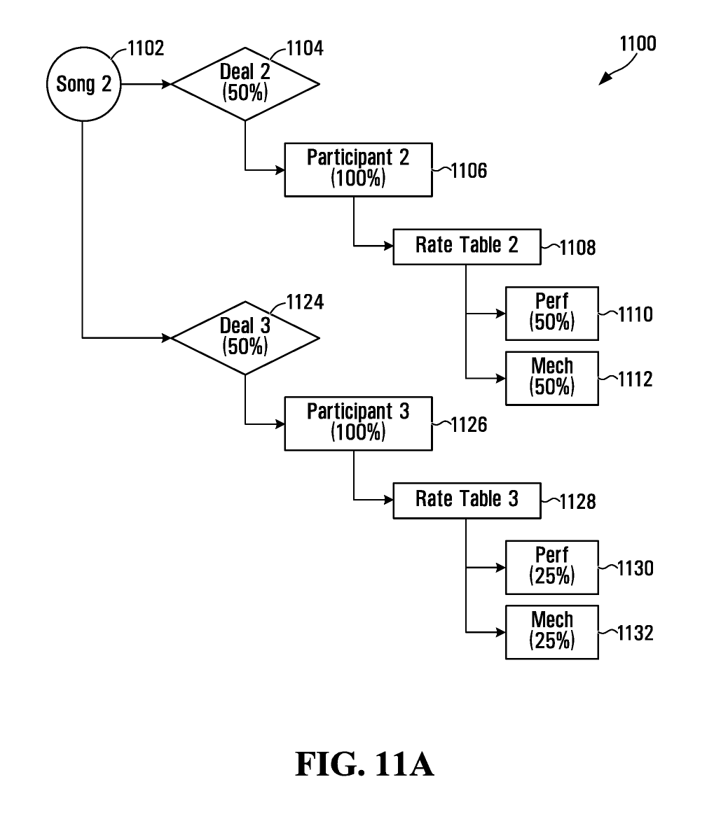

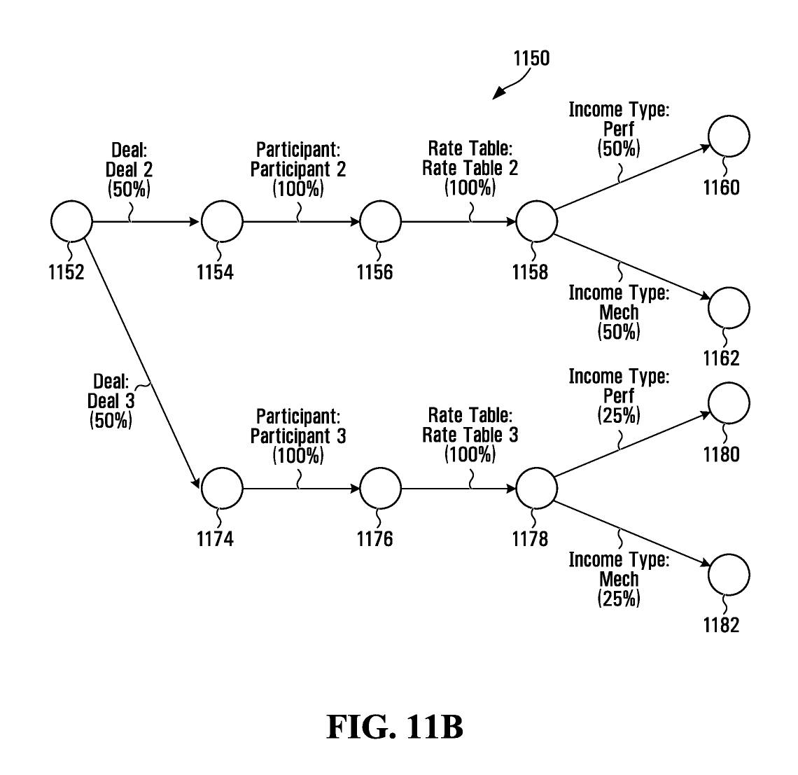

FIG. 11A illustrates a song/deal/deal asset relationship in the intellectual property rights and royalty management system where an asset is associated with multiple deals. This relationship can be represented graphically as a song 1102, which has two associated deals 1104 and 1124. Deal 1104 has a single participant 1106, and a single rate table 1108, which specifies two royalties 1110 and 1112. Deal 1124 also has a single participant 1126, and a single rate table 1128, which specifies two royalties 1130 and 1132

Based on the multiple deal relationship shown in FIG. 11A, the Dynamic Flow Network 1150 shown in FIG. 11B can be generated by the server computing device.

As an illustration of how the Dynamic Flow Network of FIG. 11B can be traversed to compute a royalty payout, the following Statement Line may be considered:

| Song | Income Type | Amount | Deals |
|---|---|---|---|
| Song 2 | Perf | $20 | Deal 2, Deal 3 |

The following Network Input can be created by the server computing device from the statement line:

```
{
  amount: $20,
  dimensions: {
    ′deals′: [′Deal 2′, ′Deal 3′],
    ′income types′: [′Perf′],
    ′participants′: [′Participant 2′, ′Participant 3′],
    ′rate tables′: [′Rate Table 2′, ′Rate Table 3′]
  }
}
```

In the example of FIG. 11B, the processor will traverse both edges from vertex 1152. Traversing the edge to vertex 1154, leads to traversing further edges up to vertex 1158. At vertex 1158, a decision will be made based on the income type and, since the input income type is “perf”, the processor will traverse the “perf” edge to vertex 1160.

Independently, the processor can also traverse the edge between vertex 1152 and vertex 1174, leading to traversing further edges up to vertex 1158. Again, since the income type is “perf” the processor will traverse the edge to vertex 1180.

Running through the same traversal algorithm described above, the following path is output:

```
[
  [
    {Deal: ″Deal 2″},
    {Participant: ″Participant 2″},
    {Income Type: ″Perf″},
    {Rate Table: ″Rate Table 2″}
  ],
  [
    {Deal: ″Deal 3″},
    {Participant: ″Participant 3″},
    {Income Type: ″Perf″},
    {Rate Table: ″Rate Table 3″}
  ]
]
```

and the following capacities:

```
[
  [50%, 100%, 100%, 50%],
  [50%, 100%, 100%, 25%]
]
```

Using this output pair, we can see that the payment for Participant 2 can be calculated at $5.00 (i.e., $20*(50%*100%*100%*50%)=>$20*25%=>$5) and for Participant 3 is $2.50 (i.e., $20*(50%*100%*100%*25%)=>$20*12.5%=>$2.50) in royalties based on the input statement line.

### Royalty Example 3: Deal Modifier

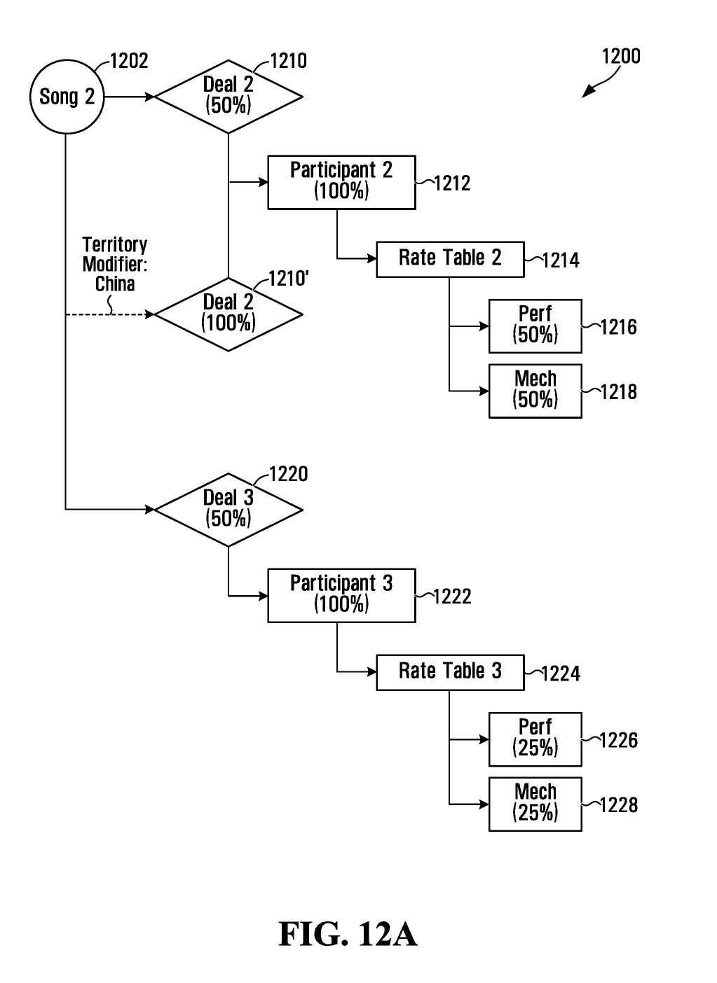

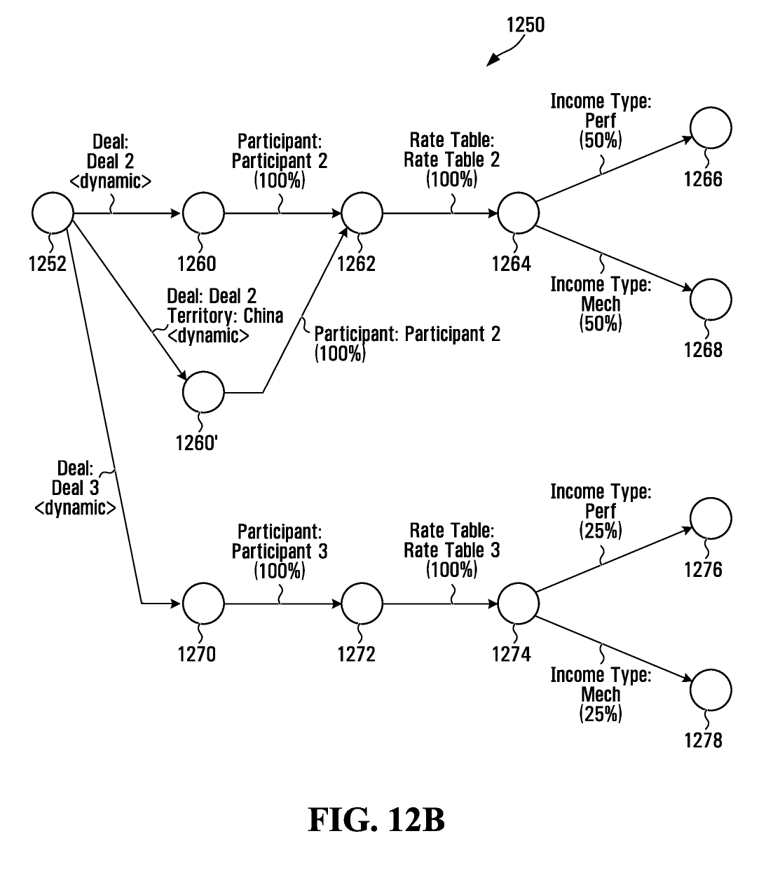

FIG. 12A illustrates a song/deal/deal asset relationship in the intellectual property rights and royalty management system where a deal contains a deal modifier regarding rights in a particular territory. This relationship can be represented graphically as a song 1202, which has two associated deals 1210 and 1220. Deal 1210 has a territory modifier applied for China, resulting in deal 1210′. Deals 1210 and 1210′ each have a single participant 1212, and a single rate table 1214, which specifies two royalties 1216 and 1218. Deal 1220 also has a single participant 1222, and a single rate table 1224, which specifies two royalties 1226 and 1228

Based on the relationship shown in FIG. 12A, the Dynamic Flow Network 1250 shown in FIG. 12B can be generated by the server computing device.

Song 1202 has the same graph structure as Song 1102 of FIG. 11A, with the exception of a Territory Deal Modifier that specifies that Deal 2 gets 100% of royalties in China (as opposed to 50% elsewhere). In the previous examples, fixed capacities were used for each deal. However, modifiers can be used to provide for different capacities or percentages in different territories, for different participants, etc. In general, this concept can be applied to each of the described examples. For example, two songs could both be on the same deal, but with different allocations. Ambiguities can be resolved based on the Network Input. To compensate for this, rather than pre-allocating the capacities, the allocations can be marked as dynamic (e.g., between vertex 1252 and vertex 1260 or vertex 1260′) and can be computed once the edge has been traversed, as demonstrated below.

As an illustration of how the Dynamic Flow Network of FIG. 12B can be traversed to compute a royalty payout, the following Statement Line may be considered:

| Song | Income Type | Amount | Deal | Territory |
|---|---|---|---|---|
| Song 3 | Perf | $20 | Deal 2 | China |

The following Network Input can be created by the server computing device from the statement line:

```
{
  amount: $20,
  dimensions: {
    ′deals′: [′Deal 2′],
    ′deal_asset_links′: [{′Deal 2/China′: 100%, ′Deal 2′: 50%, ′Deal 3′:
    50%}]
    ′income types′: [′Perf′],
    ′participants′: [′Participant 2′, ′Participant 3′],
    ′rate tables′: [′Rate Table 2′, ′Rate Table 3′],
    ′territory′: ′China′
  }
}
```

Note the additional deal_asset_links property in the dimensions object. This input need not be used for the traversal of the graph, but it can be used to compute the capacity once the traversal has occurred.

In the example of FIG. 12B, the processor will traverse the edge between vertices 1252 and 1260′. Next the processor will continue traversing edges up to vertex 1264, where it will select the edge to vertex 1266 based on the “perp” income type.

Running through the traversal algorithm, the following path is output:

```
[
  [
    {Deal: ″Deal 2″},
    {Participant: ″Participant 2″},
    {Income Type: ″Perf″},
    {Rate Table: ″Rate Table 2″}
  ]
]
```

and the following capacities:

[
[100%, 100%, 100%, 50%]
]

During traversal, the processor can identify that the deal edge is marked as dynamic and can then do a secondary lookup in the deal_assets_links list and find the appropriate deal and modifier to compute the percentage (in this case, Deal 2/China has a percentage of 100%). In general, there may be relatively few deal_asset_links per asset, so a linear search of this space should can be sufficient to find the appropriate percentage.

Finally, using this output pair, the processor can compute a payment to Participant 2 of $10.00 (i.e., $20*(100%*100%*100%*50%)=>$20*50%=>$10). Participant 3 does not get any royalties because of the Territory modifier on the deal.

### Royalty Example 4: Rate Table Modifier

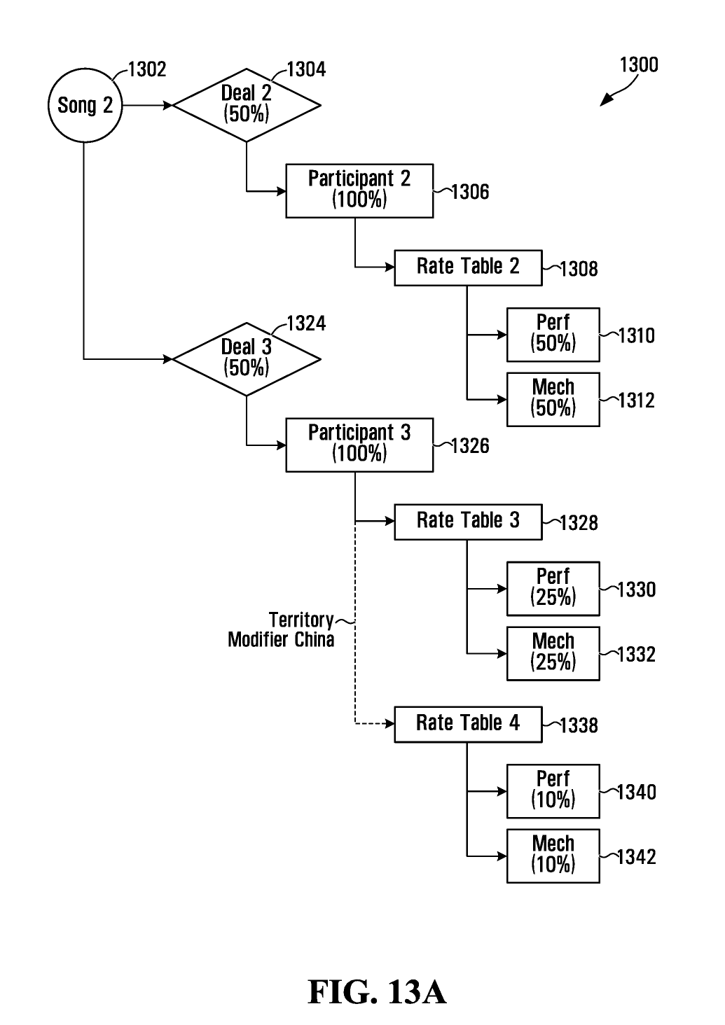

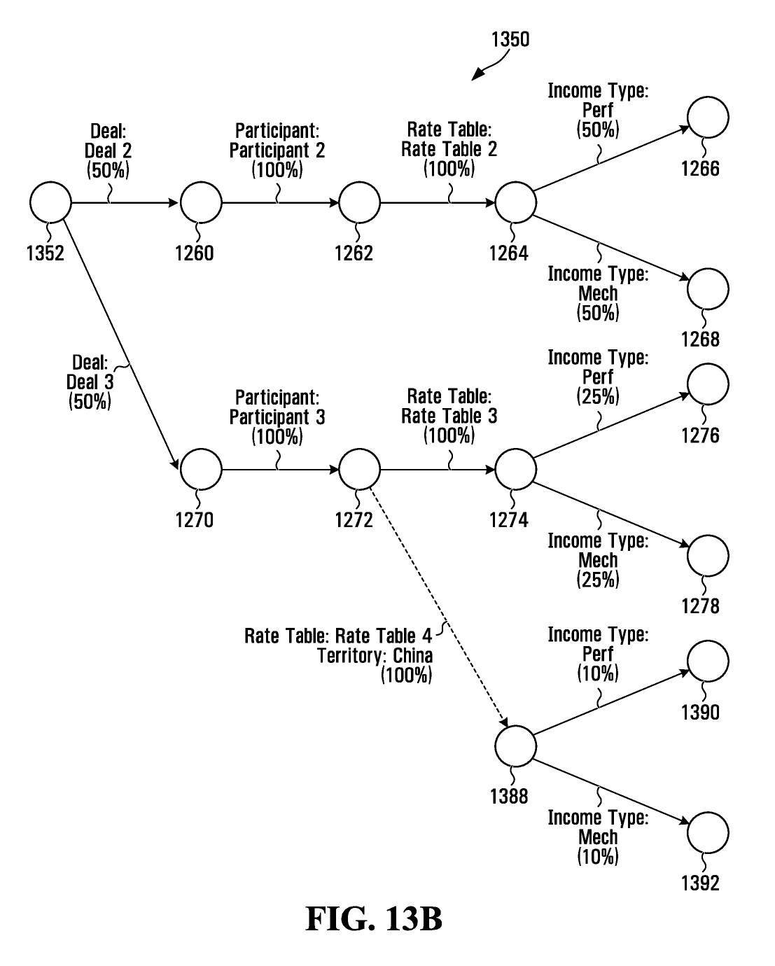

FIG. 13A illustrates a song/deal/deal asset relationship in the intellectual property rights and royalty management system where a deal contains a rate table modifier regarding rights in a particular territory. This relationship can be represented graphically as a song 1302, which has two associated deals 1304 and 1324. Deal 1304 has a participant 1306, and a single rate table 1308, which specifies two royalties 1310 and 1312. Deal 1324 has a single participant 1326, but two rate tables 1328 and 1338. Rate table 1328 has two associated royalties 1330 and 1332. Rate table 1338 is associated with a territory modifier, and has two royalties 1340 and 1342.

Based on the relationship shown in FIG. 13A, the Dynamic Flow Network 1350 shown in FIG. 13B can be generated by the server computing device.

Similar to the deal modifier example of FIG. 12B, the network 1350 can have an extra node 1388 with an extra traversal condition on it for the Rate Table Modifier that is in the schema.

Unlike in the deal modifier case, the capacities of the rate table edge are always 100% since a rate table cannot be partially applied. Therefore, there is no need for the capacity of this node to be dynamically allocated.

As an illustration of how the Dynamic Flow Network of FIG. 12B can be traversed to compute a royalty payout, the following Statement Line may be considered:

| Song | Income Type | Amount | Deal | Territory |
|---|---|---|---|---|
| Song 4 | Perf | $20 | Deal 3 | China |

The following Network Input can be created by the server computing device from the statement line:

```
{
  amount: $20,
  dimensions: {
    ′deals′: [′Deal 3′],
    ′deal_assets_links′: [{′Deal 2′: 50%, ′Deal 3′: 50%}]
    ′income types′: [′Perf′],
    ′participants′: [′Participant 2′, ′Participant 3′],
    ′rate tables′: [′Rate Table 2′, ′Rate Table 3′, ′Rate Table 4′],
    ′territory′: ′China′
  }
}
```

In the example of FIG. 13B, the processor will traverse both edges between vertex 1352 and vertices 1260 and 1270. In the first case, the processor will traverse vertices 1352, 1260, 1262, 1264 and 1266, based on the “perf” income type. In the second case, the processor will traverse vertices 1352, 1270, 1272, 1388 and 1390, based on the territory modifier and “perf” income type.

Running through the traversal algorithm, the following path is output:

```
[
  [
    {Deal: ″Deal 2″},
    {Participant: ″Participant 2″},
    {Income Type: ″Perf″},
    {Rate Table: ″Rate Table 2″}
  ],
  [
    {Deal: ″Deal 3″},
    {Participant: ″Participant 3″},
    {Income Type: ″Perf″},
    {Rate Table: ″Rate Table 4″}
  ]
]
```

and the following capacities:

```
[
  [50%, 100%, 100%, 50%],
  [50%, 100%, 100%, 10%]
]
```

Finally using this output pair, the processor can compute payment to Participant 2 is $5.00 (i.e., $20*(50%*100%*100%*50%)=>$20*25%=>$5), and payment to Participant 3 is $1 (i.e., $20*(50%*100%*100%*10%)=>$20*10%=>$1), based on the territory modifier.

### Royalty Example 5: Combining Networks

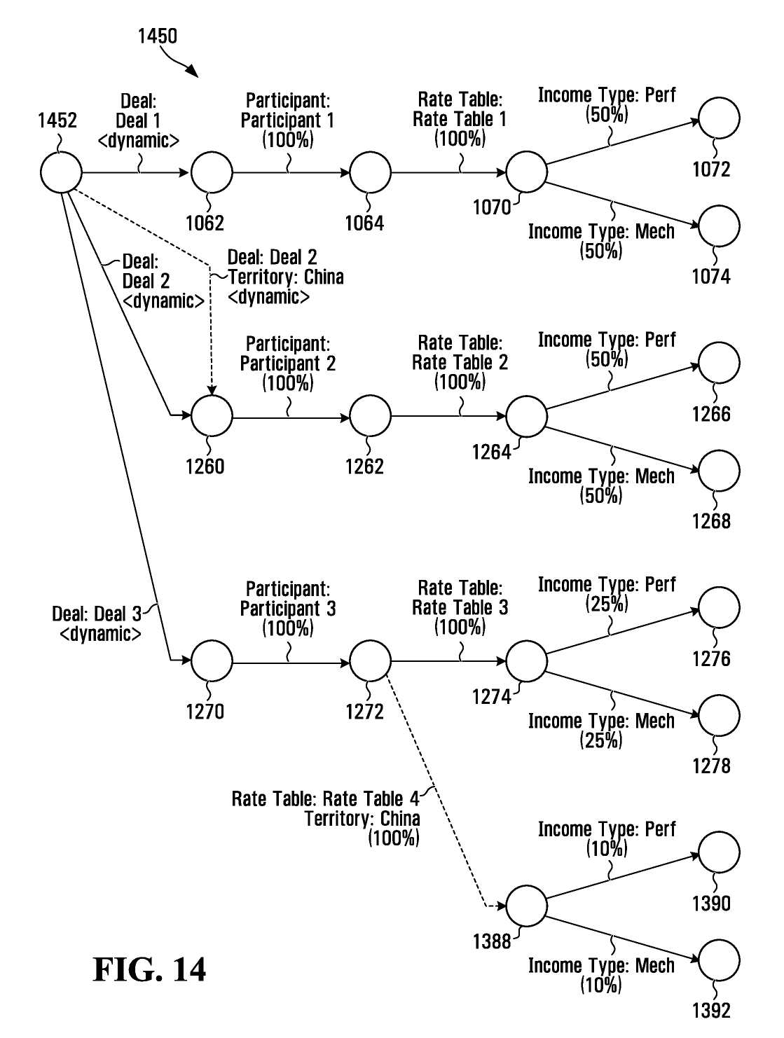

Dynamic flow networks can be particularly useful when a number of individual sub-networks are combined. To illustrate this, FIG. 14 is a dynamic flow network 1450 that is the result of the server computing device combining the flow networks of the previous four examples (i.e., networks 1050, 1150, 1250 and 1350).

Using the dynamic capacities described in the deal modifier example of FIG. 12B, all statement lines can be routed through this combined flow network and can receive the same traversal and capacity structures as when the flow network is independently constructed for each asset.

Additionally, because of the nature of this flow network structure, multiple network inputs can be run through the flow network concurrently and make use of the resources available to multiple processor systems with minimal changes to the architecture, thus providing for enhance scalability of the system.

Referring again to FIG. 4, a Period Close can be initiated at 450. At 452, the user can review and resolve any errors related to statement line matching, royalty calculations and financial transactions and can generate Period Close Reports. The Period Close Reports can include Statement Royalty Summary, Source Royalty Summary, Statement Header Summary, Financial Transactions, and Statement Errors. At 454, the exchange rates for each payee currency used in the intellectual property rights and royalty management system can be input. At 456, the period can be closed by archiving Reviewed statements and moving open and held statements to the next reporting period. Period Close 450 can also include the ability to export data, to recalculate the period, to navigate to statement lines and errors, and initiate a system freeze on Reviewed statements.

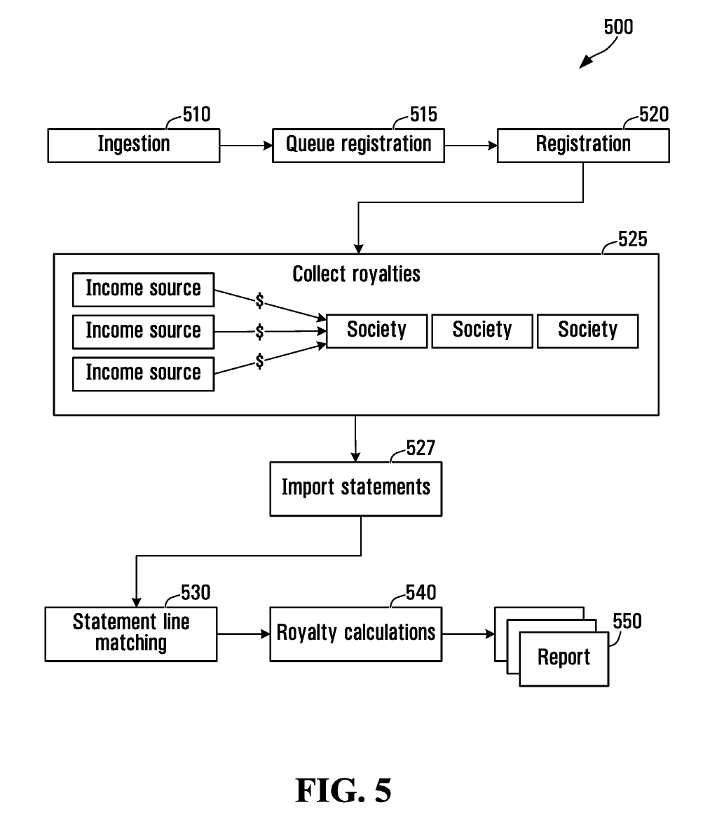

Referring now to FIG. 5, there is illustrated a simplified process flow in accordance with at least some embodiments. Process 500 may be executed, e.g., using the system 5 of FIG. 1.

Process 500 begins at 510 with asset ingestion, which may be carried out, for example, using ingestion flow 200B of FIG. 2B. At 515, assets may be queued for registration and at 520 registration may take place, for example using registration flow 300 of FIG. 3.

At 525, collective societies or other parties may generate income statements based on the collection of royalties, and may transmit the income statements to system 5. At 527, the income statements can be imported. Statement line matching can be performed at 530, for example as described in process 400 of FIG. 4.

At 540, royalty calculations can be carried out, as described herein, and at 550 reporting and payment can be performed.

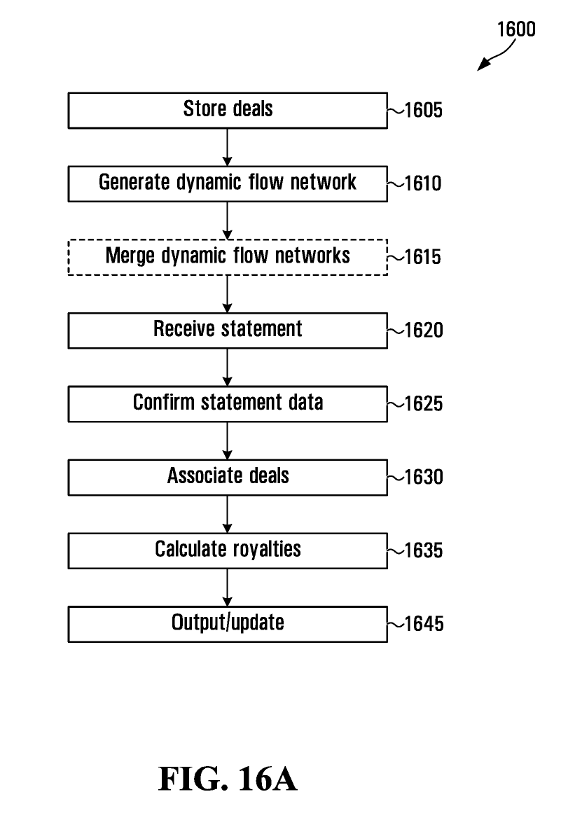

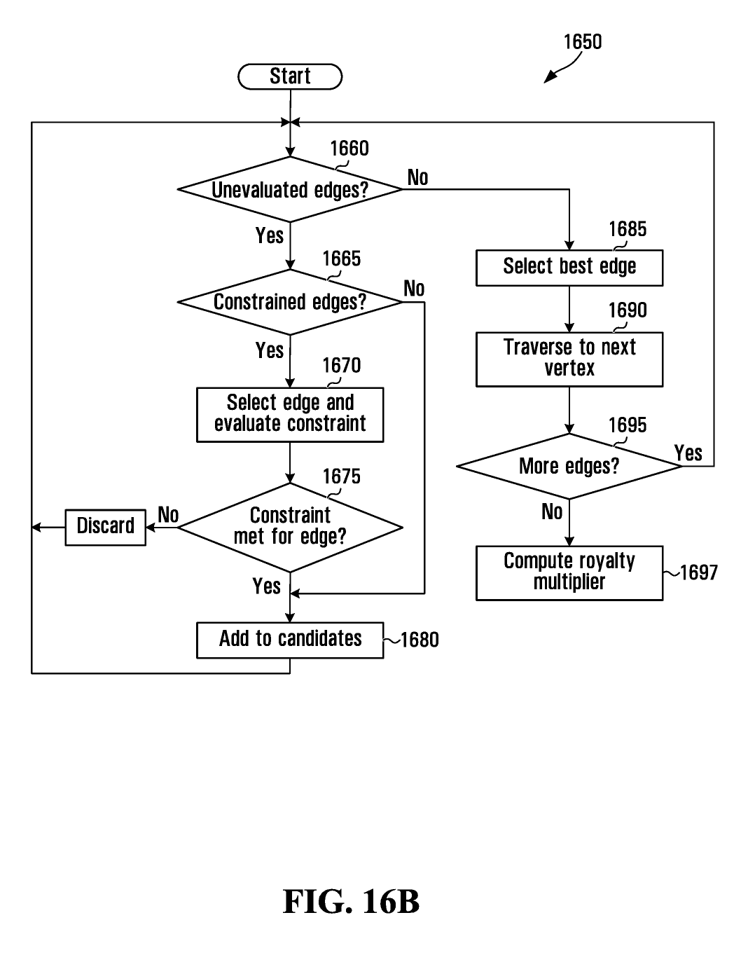

Referring now to FIG. 16A, there is illustrated a process flow diagram of a method for scalable computing in a computing device in accordance with at least some embodiments. Process 1600 may be executed, e.g., using the system 5 of FIG. 1 and, in particular, by server computing device 10 of system 5.

Process 1600 may begin at 1605, with the server computing device creating and storing a plurality of deals in a database as described herein for example with reference to FIG. 2A. The server computing device may also ingest and register assets, as described herein for example with reference to FIGS. 2B and 3. Accordingly, each of the plurality of deals may have associated therewith at least one deal asset. That is, each deal asset can be associated with at least one of the plurality of deals, at least one rate table and at least one rights holder;

In some embodiments, one or more deals may have a modifier or parameter associated with it, such as a territory parameter. The territory parameter can modify the calculation of a deal royalty payment as described herein.

At 1610, the server computing device may generate one or more dynamic flow networks for each deal asset, and based on a deal or plurality of deals associated with the deal asset. If there are a plurality of deals associated with the deal asset, the server computing device may merge the dynamic flow networks for each deal into a merged dynamic flow network for the deal asset, at 1615.

A dynamic flow network has a plurality of edges and vertices (or nodes), as described with reference to FIGS. 10B, 11B, 12B, 13B and 14. A deal asset can also be associated with at least one statement asset, at least one rate table, and at least one rights holder.

Each of the edges may have a respective capacity value or dimension, which is representative of a value to be applied to a royalty calculation when the edge is traversed. Generally, the capacity value applied to an edge is selected from a finite set of values. For example, the capacity value may be an integer percentage value (e.g., from 0-100%). However, in some embodiments, the capacity value may be any value within a predetermined range (e.g., any value between 0-100%).

In some cases, at least one of the plurality of edges may be a constrained edge, that has a respective constraint applied to it. For example, the constraint may be a modifier or parameter, such as a territory parameter, which indicates that the edge should only be traversed for calculations of royalties that meet the constraint condition (e.g., for a particular territory).

When the server computing device reaches a constrained edge, it may evaluate a condition based on the constraint and input deal asset to determine whether to follow the edge.

At 1620, the server computing device may receive at least one statement of royalties from at least one income source. Generally, the statement of royalties will have at least one statement line with statement line data, and each statement line will correspond to a statement asset.

At 1625, the server computing device can conform the statement line data from each statement line into conformed data, or a plurality of conformed data, as described for example with respect to FIGS. 8 and 9. Generally, the conformed data will be in a common format used by the server computing device.

At 1630, the server computing device can use the conformed data to associate the statement assets from the statement of royalties to the deal assets stored in its database, as described for example with respect to FIGS. 8 and 9. For example, the association may be performed automatically and/or using fuzzy matching, as described herein. In some cases, the association may be performed with input from a user.

At 1635, the server computing device can calculate a deal royalty payment payable to at least one rights holder based on the at least one of the plurality of deals associated with the at least one deal asset associated with the at least one statement asset and the at least one rate table. The calculating may be carried out by the server computing device traversing the dynamic flow network constructed at 1610 and/or 1615 to determine multipliers to be applied to each income amount for a deal asset and for a particular rights holder.

Although illustrated as occurring in linear fashion, the calculation at 1635 may be carried out in parallel for each deal asset in the plurality of deal assets.

At 1645, the output of each dynamic flow network can be used to compute a royalty payment for each rights holder based on the input statement assets, and the resulting outputs stored in a system database or transmitted to the rights holder or other party.

Referring now to FIG. 16B, there is illustrated a process flow diagram of a method traversing a dynamic flow network to compute a dynamic flow network output, such as a multiplier to apply to a statement asset income amount for payment to a rights holder, and for use by a computing device in accordance with at least some embodiments. Process 1650 may be executed, e.g., at 1635 of process 1600.

Process 1650 may begin at 1655 with receipt of a dynamic flow network or merged dynamic flow network, which may have been generated at 1610 or 1615 of process 1600, and by locating an origin vertex or node of the dynamic flow network.

At 1660, the server computing device determines whether there are any unevaluated edges emanating from the node. If yes, then the server computing device determines whether any of the unevaluated edges are constrained edges at 1665. If there are no constraints on the edge, it may be immediately added to a list of traversal candidates at 1680.

If there are constraints on the edge, the constraints may be evaluated at 1675. If the constraint is not met, the edge may be discarded at 1677 and the server computing device returns to 1660. If the edge constraint is met, the constrained edge may be added to a list of traversal candidates at 1680.

If, at 1660, there are no more unevaluated edges, then the server computing device may be determine a best edge to follow at 1685, based on the highest scoring edge. At 1690, the server computing device may traverse the selected edge to the next vertex.

At 1695, the server computing device may determine if there are any further edges that emanate from the newly selected vertex and, if there are, may return to 1655. Otherwise, the server computing device may determine that the dynamic flow network has been traversed and compute a royalty multiplier based on the traversed edges at 1697, and as described herein.

In some embodiments, a collective rights society can provide to rights managers a statement of assets associated with unclaimed royalties. The same statement line matching and royalty calculation methods described above can be used to match the assets in the intellectual property rights and royalty management system with the assets listed with unclaimed royalties. In some embodiments, the rights manager can be unable to disclose the statement of assets associated with unclaimed royalties. The rights manager can provide a system and method wherein a third party can provide to the rights manager a list of assets similar to that described above for generating the list of assets. The rights manager can perform the statement line matching as described above to determine if there are any unpaid royalties associated with the third party's assets.

Whether or not the third party's assets match any of the assets on the statement of assets associated with unclaimed royalties, the third party can engage the rights manager to manage the third party's intellectual property rights and royalty payments. The one or more deals could be created and associated to the third party's assets as described above.

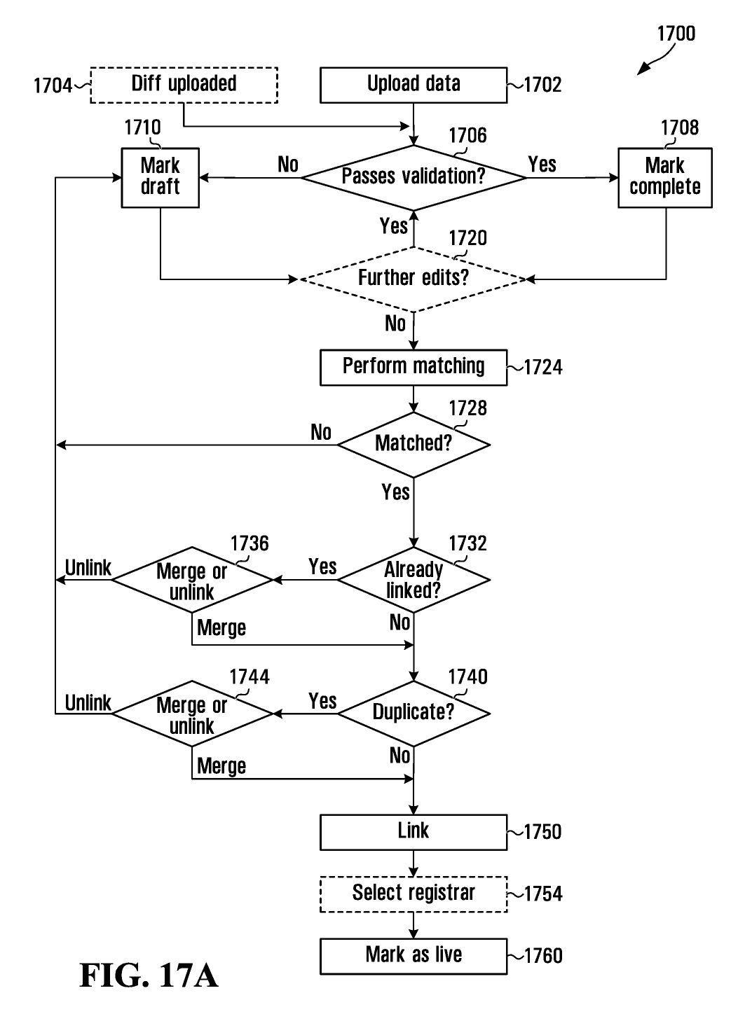

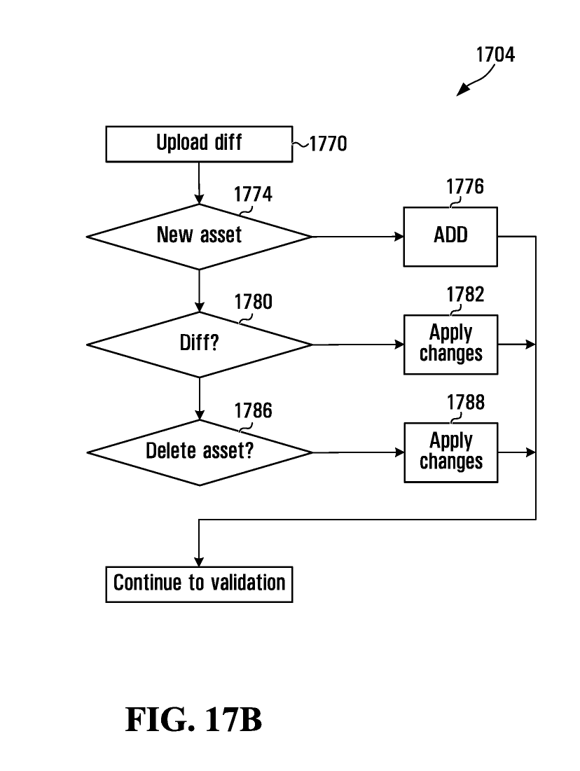

Referring now to FIGS. 17A and 17B, there is illustrated a process flow diagram for ingesting and registering assets in accordance with at least some embodiments. Process 1700 may be performed, for example, by elements of system 5 of FIG. 1, such as server computing device 10.

Process 1700 may begin at 1702 with uploading of, or receiving, asset inventory data to the server computing device. In some cases, the asset inventory data may also be edited by a user at this stage.

At 1706, the asset inventory data can be validated by the server computing device and, in particular, each deal asset can be validated individually. Validation may involve verifying that the total deal share equals 100% for all participants, and that the asset data or metadata (e.g., composer) is valid and meets formatting standards. If the asset does not pass validation, it may be marked as draft at 1710 until further editing is performed by a user at 1720.

If the asset passes validation testing, it may be marked as complete at 1708. Optionally, further editing may permitted at 1720 for as long as the asset remains marked as complete or draft.

Following editing, matching of assets may be attempted by the server computing device to existing known assets at 1728. Matching may be performed for draft assets and/or for complete assets. Matching may be manual (e.g., involving a user) or may be automatic (e.g., fuzzy matching or other automatic matching), as described elsewhere herein. Automatic matching may be based, for example, on a unique identifier, an ISWC code, an ISAN code, work numbers, metadata, hash codes, etc. If matching is unsuccessful, the server computing device may return to 1710.

If matching is successful, the server computing device may attempt to determine whether the match is to an asset that is already marked as live at 1732. This may occur, for example, when an asset is uploaded as part of a batch and a pre-existing asset already exists. When a proposed match is found that is to an existing live asset, the server computing device may query a user whether to merge the two assets or to unlink the proposed matched assets.

When the user selects to merge the two assets, any empty attributes of the live asset may be replaced with corresponding attributes of the newly-added asset. Work numbers and statement lines may be merged. Other attributes, such as deal assets, composers, etc., may be replaced by those from the newly-added asset. A user may select to manually override defaults and edit attributes as desired.

When the user selects to unlink the two assets, the server computing device may discard the proposed match and return to 1710.

At 1740, the server computing device may attempt to determine whether the match is to a duplicate asset. When a proposed match is found that appears to be a duplicate, the system may query a user whether to merge the two assets or to unlink the proposed matched assets.

When the user selects to merge the two assets, any empty attributes of the live asset may be replaced with corresponding attributes of the newly-added asset. Work numbers and statement lines may be merged. Other attributes, such as deal assets, composers, etc., may be replaced by those from the newly-added asset. A user may select to manually override defaults and edit attributes as desired.

At 1750, the proposed match can be accepted and the newly-added asset can be linked to a live asset by the server computing device.

For certain types of assets, a registrar or collective society association can be made at 1754.

At 1760, the asset can be marked as live. In some cases, an auto-matched asset can be marked as live immediately following its being marked as complete.

Referring now to 17B, there is illustrated a process flow diagram for uploading diff inventory data in accordance with at least some embodiments. Diff inventory data may be uploaded, e.g., at 1704 of process 1700, for example. Diff inventory data may be used to explicitly identify assets to be added, changed or removed from the system database.

At 1770, the diff inventory data can be uploaded or received. For each asset in the diff inventory data, the server computing device can check: a) whether the asset is a new asset at 1774, in which case the asset can be added at 1776; b) whether the asset is a changed asset at 1780, in which case it can be matched and changes applied at 1782; and c) whether the asset is to be deleted at 1786, in which case the corresponding asset can be deleted from the database at 1788. At 1790, the server computing device can continue to validation, e.g., at 1706 of process 1700.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

1. A method for scalable computing in a computing device, the method comprising:
storing a plurality of deals in a database of a computing device, each of the plurality of deals having associated therewith at least one deal asset, the at least one deal asset associated with at least one of the plurality of deals, at least one rate table and at least one rights holder;
receiving, by the computing device, at least one statement of royalties from at least one income source, the statement comprising at least one statement line, the statement line corresponding to a statement asset, the statement line comprising a plurality of statement line data;
conforming, by the computing device, the plurality of statement line data from each of the at least one statement lines in each of the at least one statements received from each of the at least one income sources into a plurality of conformed data, wherein each of the plurality of conformed data is in a common format;
associating, by the computing device, using the plurality of conformed data, the at least one statement asset with the at least one deal asset;
calculating, by the computing device, a deal royalty payment payable to the at least one rights holder based on the at least one of the plurality of deals associated with the at least one deal asset associated with the at least one statement asset and the at least one rate table.

2. The method of claim 1, wherein the associating is performed using fuzzy matching.

3. The method of claim 1, wherein the at least one of the plurality of deals further comprises at least one territory parameter, the territory parameter modifying the calculation of the deal royalty payment.

4. The method of claim 1, further comprising generating a dynamic flow network for each at least one deal asset, wherein each dynamic flow network comprises a plurality of edges and a plurality of vertices.

5. The method of claim 4, wherein each of the plurality of edges has a respective capacity value.

6. The method of claim 5, wherein the respective capacity value is selected from a finite set of values.

7. The method of claim 4, wherein at least one constrained edge of the plurality of edges has a respective constraint.

8. The method of claim 7, wherein each of the at least one constrained edge has a respective entry vertex of the plurality of vertices, and wherein for each respective entry vertex, the method further comprises determining whether an edge constraint of the at least one constrained edge is met by the at least one deal asset.

9. The method of claim 1, further comprising generating a dynamic flow network based on the at least one of the plurality of deals associated with the at least one deal asset associated with the at least one statement asset, the at least one rate table, and the at least one rights holder, wherein the calculating comprises traversing the dynamic flow network.

10. The method of claim 9, wherein the at least one deal asset is associated with a plurality of associated deals, the method further comprising the computing device generating a plurality of dynamic flow networks for the plurality of associated deals, and merging the plurality of dynamic flow networks into a merged dynamic flow network.

11. The method of claim 4, further comprising processing the dynamic flow network for each at least one deal asset in parallel.

12. The method of claim 1, further comprising the step of submitting, by the computing device, the at least one deal asset to a registrar of an income source for registration of the at least one deal asset with the registrar.

13. A scalable computing system for managing intellectual property rights and royalties, the system comprising:
a database including storing a plurality of deals, each of the plurality of deals having associated therewith at least one deal asset, the at least one deal asset associated with at least one of the plurality of deals, at least one rate table and at least one rights holder; and
a computing device configured to:
receive at least one statement of royalties from at least one income source, the statement comprising at least one statement line, the statement line corresponding to a statement asset, the statement line comprising a plurality of statement line data;
conform the plurality of statement line data from each of the at least one statement lines in each of the at least one statements received from each of the at least one income sources into a plurality of conformed data, wherein each of the plurality of conformed data is in a common format;
associate using the plurality of conformed data, the at least one statement asset with the at least one deal asset;
calculate a deal royalty payment payable to the at least one rights holder based on the at least one of the plurality of deals associated with the at least one deal asset associated with the at least one statement asset and the at least one rate table.

14. The system of claim 13, wherein the computing device is further configured to associate the at least one statement asset with the at least one deal asset using fuzzy matching.

15. The system of claim 13, wherein the at least one of the plurality of deals further comprises at least one territory parameter, the territory parameter modifying the calculation of the deal royalty payment.

16. The system of claim 13, the computing device further configured to generate a dynamic flow network for each at least one deal asset, wherein each dynamic flow network comprises a plurality of edges and a plurality of vertices.

17. The system of claim 16, wherein each of the plurality of edges has a respective capacity value, wherein the respective capacity value is selected from a finite set of values.

18. The system of claim 16, wherein at least one constrained edge of the plurality of edges has a respective constraint, wherein each of the at least one constrained edge has a respective entry vertex of the plurality of vertices, and wherein for each respective entry vertex, the computing device is further configured to determine whether an edge constraint of the at least one constrained edge is met by the at least one deal asset.

19. The system of claim 13, the computing device further configured to generate a dynamic flow network based on the at least one of the plurality of deals associated with the at least one deal asset associated with the at least one statement asset, the at least one rate table, and the at least one rights holder, where in the computing device is configured to calculate a deal royalty payment payable after traversing the dynamic flow network.

20. The system of claim 16, wherein the at least one deal asset is associated with a plurality of associated deals, the computing device further configured to generate a plurality of dynamic flow networks for the plurality of associated deals, and merge the plurality of dynamic flow networks into a merged dynamic flow network.

21. The system of claim 13, further comprising a plurality of computing devices, each of the computing devices configured to process the dynamic flow network for each at least one deal asset in parallel.

22. The system of claim 13, the computing device further configured to submit the at least one deal asset to a registrar of an income source for registration of the at least one deal asset with the registrar.

23. A non-transitory computer readable medium storing instructions executable by a processor, the instructions when executed by the processor causing the processor to carry out a method for scalable computing in a computing device, the method comprising:
storing a plurality of deals in a database of a computing device, each of the plurality of deals having associated therewith at least one deal asset, the at least one deal asset associated with at least one of the plurality of deals, at least one rate table and at least one rights holder;
receiving, by the computing device, at least one statement of royalties from at least one income source, the statement comprising at least one statement line, the statement line corresponding to a statement asset, the statement line comprising a plurality of statement line data;
conforming, by the computing device, the plurality of statement line data from each of the at least one statement lines in each of the at least one statements received from each of the at least one income sources into a plurality of conformed data, wherein each of the plurality of conformed data is in a common format;
associating, by the computing device, using the plurality of conformed data, the at least one statement asset with the at least one deal asset;
calculating, by the computing device, a deal royalty payment payable to the at least one rights holder based on the at least one of the plurality of deals associated with the at least one deal asset associated with the at least one statement asset and the at least one rate table.
